(19) United States
(12) Patent Application Publication
(10) Pub. No.: US 2019/0158484 A1
(43) Pub. Date: May 23, 2019

(54) Gaming Moments and Groups on Online Gaming Platforms

(71) Applicant: Facebook, Inc., Menlo Park, CA (US)

(72) Inventors: Calvin Patrick Grunewald, Issaquah, WA (US); Alexander Irvin Hopmann, Seattle, WA (US); Li Ju, Issaquah, WA (US); James Caruso, Seattle, WA (US); Kun Chen, Kirkland, WA (US); Pooya Karimian, Mountain View, CA (US)

(21) Appl. No.: 15/820,234

(22) Filed: Nov. 21, 2017

(51) Int. Cl. H04L 29/06; G06N 99/00; G06Q 50/00; H04L 12/58; A63F 13/73; A63F 13/35; A63F 13/87

(52) U.S. Cl. CPC H04L 63/083; G06N 99/005; G06Q 50/01; H04L 67/02; A63F 13/73; A63F 13/35; A63F 13/87; H04L 51/32

(57) ABSTRACT

In one embodiment, a method includes receiving, from a client system of a first user of an online social network, an indication the first user is accessing a gaming platform; authenticating the first user to access to the gaming platform; receiving, from the gaming platform, a request to access social-networking information associated with the first user; providing, to the gaming platform, access to the social-networking information; receiving, from the gaming platform responsive to a call to a sharing-moments application programming interface (API), gaming-moment information that includes references to one or more in-game actions of the first user in a first game hosted on the gaming platform and metadata associated with each of the one or more in-game actions; and providing, to the client system of the first user, the gaming-moment information within one or more social contexts on the online social network.

### TECHNICAL FIELD

This disclosure generally relates to online games and enhancing the online gameplay experience within an online communications environment, such as those for online messaging or social-networking systems.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

Online games are now played on various types of computing devices. An online game is a game that is either partially or primarily played by one or more users who communicate through the Internet or other data communication protocols. Conventional online game sessions are hosted or managed by a game server, which is typically one or more dedicated computers managed by the game publisher or other company. Users typically initiate online game sessions by directly accessing a web page of a third-part game server. Alternatively, applications or console games may communicate with a server to exchange score information, game updates, etc.

Gaming platforms (which may be a separate entity or part of a social-networking system) have become a useful way to host various online games that users can engage in playing. Users can access a gaming platform through their client systems. The gaming platform may enable a user to play a game either independently or in collaboration with one or more other users. The gaming platform has a potential to engage user(s) in online games and to enhance their gameplay experience.

### SUMMARY OF PARTICULAR EMBODIMENTS

In particular embodiments, a social-networking system may share gaming-moment information on one or more social contexts within an online social network. The gaming-moment information may include references to one or more in-game actions of user in a game. For example, the gaming-moment information may include, as an example and not by way of limitation, in-game highlights, game screenshots, live media streams, user achievements, user gameplays, etc. The social-networking system may share the gaming-moment information on one or more social contexts. The one or more social contexts may include a user's personal gamefeed space, one or more gaming groups, one or more message threads of a messaging application of the online social network, and/or a social media feed or newsfeed space on the online social network. The social-networking system may receive the gaming-moment information from a gaming platform. The gaming platform may host one or more games that the user can play. The gaming platform may be one of a web-based gaming platform that may be located on and is part of the online social network itself, a desktop-based gaming platform that may integrate one or more social-networking features of the online social network, or a messaging-application based gaming platform that may be integrated into a messaging application of the online social network In particular embodiments, the gaming platform may authenticate the user to play a game via a single sign-on (SSO) process in cooperation with the social-networking system. For example, the gaming platform may receive user login credentials (e.g., username, password) from the social-networking system and use that to authenticate the user and provide access to the game. In particular embodiments, the social-networking system may receive the gaming moment information from the gaming platform via a sharing-moments application programming interface (API). For example, upon receiving a request, the social-networking system may provide its sharing-moments API to the gaming platform, which may then call this API to send gaming-moment information to the social-networking system for sharing.

In particular embodiments, the social-networking system may provide various gaming-context APIs that the gaming platform can use to enhance user gameplay experience when the user is playing one or more games hosted on the gaming platform. In particular embodiments, the gaming platform may be a messaging-application-based gaming platform, which is integrated into a messaging application of the online social network. The messaging-application-based gaming platform may allow users to access games for playing from within a messaging application using a games tab (as discussed in U.S. patent application Ser. No. 15/783,885, filed 13 Oct. 2017, hereby incorporated by reference), receive game-related messages inside a message thread from a game bot (as discussed in U.S. patent application Ser. No. 15/783,936, filed 13 Oct. 2017, hereby incorporated by reference), and play games with other users from inside message threads (aka gameplay threads) (as discussed in U.S. patent application Ser. No. 15/783,905, filed 13 Oct. 2017, hereby incorporated by reference). Using the gaming-context APIs of the social-networking system, the gaming platform may provide rich gameplay features to users of its platform when playing games. These gaming-context APIs may include a switch-context API, a choose-context API, a connected-player API, a sharing-moment API, and a customized-message API. Using the switch-context API, the gaming platform may enable seamless switching between various game contexts so that a user may simultaneously play one or more games with one or more other users. For example, using this API, the gaming platform may enable a first user to switch from a first game context (e.g., a first message thread running a first game between the first user and a second user) to a second game context (e.g., a second message thread running the first game between the first user and a third user). Using the choose-context API, the gaming platform may provide a list of all of a user's connections (e.g., social contacts on the online social network) who have not yet played a game. This API may thus provide a way for the user to invite friends or new people to try out the game. Using the connected-player API, the gaming platform may return a list of player IDs for a game that can be used to compare performance metrics (e.g., score, rank) of a first player with second players in the game. For example, using this API, the gaming platform may generate a game leaderboard showing a user score for a game relative to other users scores when they played the same game before. Using the sharing-moments API, the gaming platform may share gaming-moment information (e.g., in-game highlights, user gameplays, user achievements, etc.) on one or more social contexts (e.g., user personal gamefeed space, message thread(s), social group(s)) within the online social network. Using the custom-message API, the gaming platform may provide customized messages to a user in a message thread (as discussed in U.S. patent application Ser. No. 15/783,936, filed 13 Oct. 2017). A customized message may include, for example, a game screenshot or animated clip (which may show a short preview of a user's gameplay), a user icon showing a picture of the user playing the game, score/rank that the user achieved in the game, a customizable text, and a customizable action button. These gaming-context APIs may be used for different game types or game genres.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 is a block diagram illustrating an example environment in which a client system, a social-networking system, and a gaming platform may interact with each other.

FIG. 3 is an example interaction/flow diagram illustrating example interactions between a client system, a gaming platform, and a social-networking system.

FIG. 4 illustrates an example social graph.

FIG. 5 illustrates an example gamer graph.

FIG. 6 is an interaction diagram showing an example interaction between a gaming platform and a social-networking system regarding sharing of gaming-moment information on social contexts within an online social network.

FIG. 7 is a user interface that shows accessing a gaming platform from within an online social network.

FIGS. 8A-8D are user interfaces showing various social network features within the gaming platform.

FIGS. 9A-9E are user interfaces showing an example sharing of a gaming moment on a social context within an online social network.

FIG. 10 is a flowchart of an example method for providing gaming-moment information referencing in-game actions of a user in a game within one or more social contexts on an online social network.

FIGS. 11A-C illustrate a first example scenario of switching game contexts from a first game context to a second game context via a switch-context API.

FIGS. 12A-C illustrate a second example scenario of switching game contexts from a first game context to a second game context via the switch-context API.

FIG. 13 is a user interface displaying a list of friends for inviting to play a game via a choose-context API.

FIG. 14 is a user interface displaying a leaderboard for a game via a connected-player API.

FIGS. 15A and 15B are user interfaces showing an example of sharing a gaming moment on a social context within an online social network via a sharing-moments API.

FIG. 16 is a user interface showing an example customized message that may be sent in a message thread for a game using a custom-message API.

FIG. 17 is a flowchart of an example method for switching game contexts from a first game context to a second game context.

FIG. 18 illustrates an example computer system.

### DESCRIPTION OF EXAMPLE EMBODIMENTS

System Overview

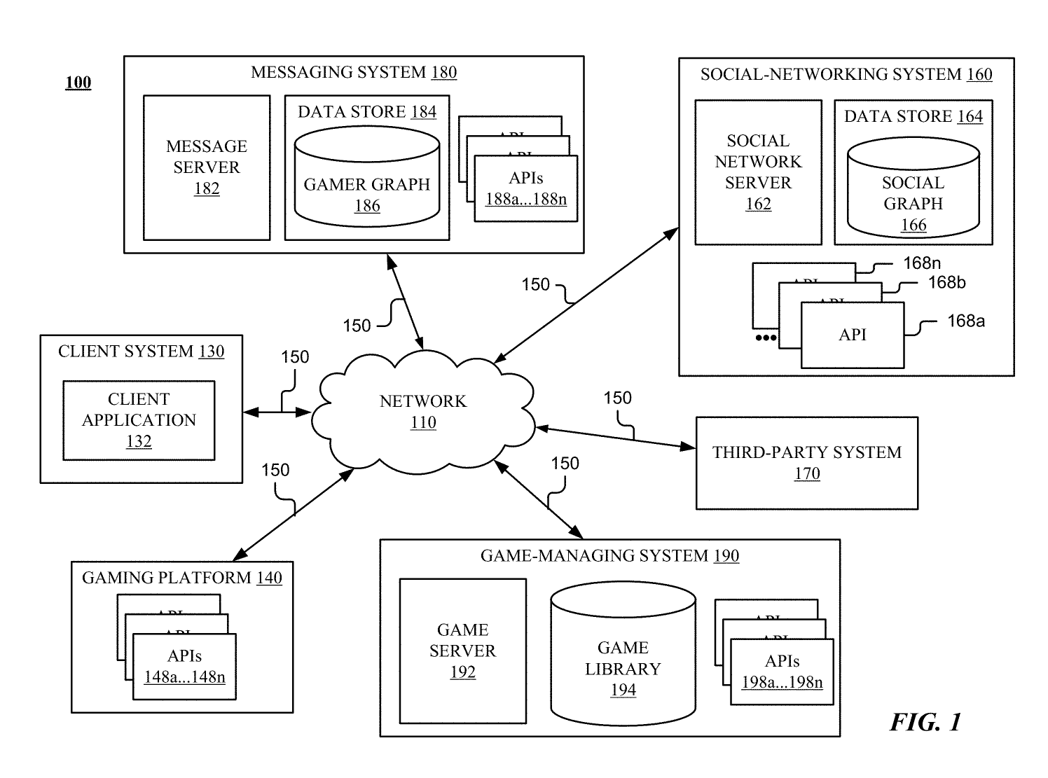

FIG. 1 illustrates an example network environment 100 associated with a social-networking system. Network environment 100 includes a client system 130, a gaming platform 140, a social-networking system 160, a third-party system 170, a messaging system 180, and a game-managing system 190 connected to each other by a network 110. Although FIG. 1 illustrates a particular arrangement of a client system 130, a gaming platform 140, a social-networking system 160, a third-party system 170, a messaging system 180, a game-managing system 190, and a network 110, this disclosure contemplates any suitable arrangement of a client system 130, a gaming platform 140, a social-networking system 160, a third-party system 170, a messaging system 180, a game-managing system 190, and a network 110. As an example and not by way of limitation, two or more of a client system 130, a gaming platform 140, a social-networking system 160, a third-party system 170, a messaging system 180, and a game-managing system 190 may be connected to each other directly, bypassing a network 110. As another example, two or more of a client system 130, a gaming platform 140, a social-networking system 160, a third-party system 170, a messaging system 180, and a game-managing system 190 may be physically or logically co-located with each other in whole or in part. Moreover, although FIG. 1 illustrates a particular number of client systems 130, gaming platforms 140, social-networking systems 160, third-party systems 170, messaging systems 180, game-managing systems 190, and networks 110, this disclosure contemplates any suitable number of client systems 130, gaming platforms 140, social-networking systems 160, third-party systems 170, messaging systems 180, game-managing systems 190, and networks 110. As an example and not by way of limitation, network environment 100 may include multiple client systems 130, gaming platforms 140, social-networking systems 160, third-party systems 170, messaging systems 180, game-managing systems 190, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a gaming platform 140, a social-networking system 160, a third-party system 170, a messaging system 180, and a game-managing system 190 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a client application 132, which may be a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser to a particular server (such as social network server 162, message server 182, game server 192, or a server associated with a third-party system 170), and the web browser may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the client application 132 may be an application operable to provide various computing functionalities, services, and/or resources, and to send data to and receive data from the other entities of the network 110, such as the gaming platform 140, social-networking system 160, the third-party system 170, the messaging system 180, and/or the game-managing system 190. For example, the client application 132 may be a social-networking application, a messaging application for messaging with users of a messaging network/system, a gaming application, an internet searching application, etc.

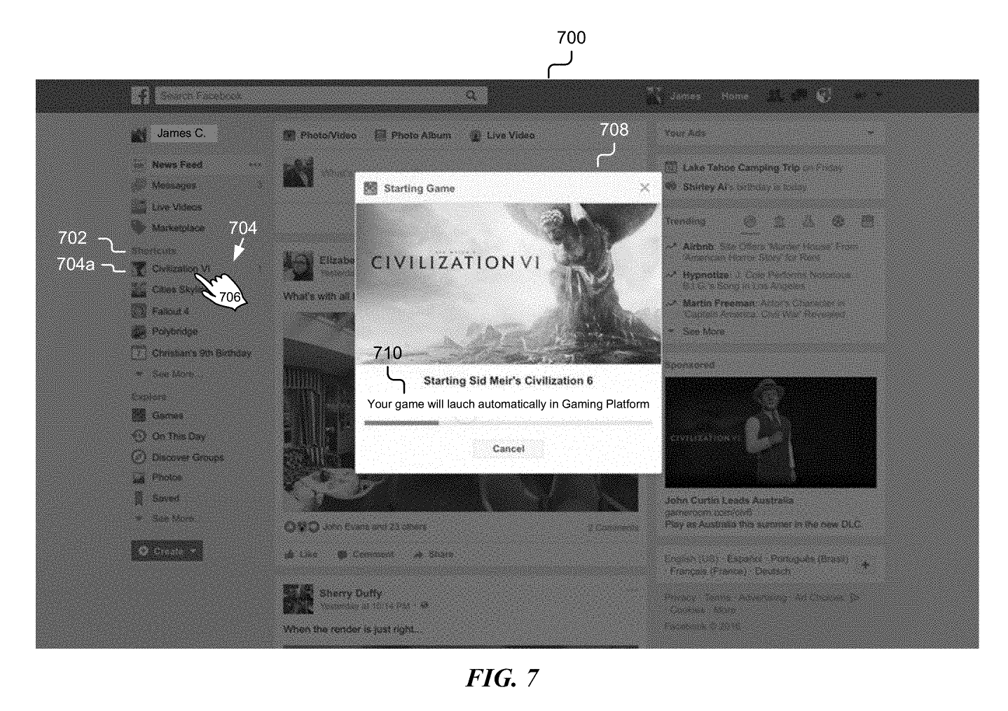

In particular embodiments, the client application 132 may be storable in a memory and executable by a processor of the client system 130 to render user interfaces, receive user input, send data to and receive data from one or more of the gaming platform 140, the social-networking system 160, the third-party system 170, the messaging system 180, and the game-managing system 190. The client application 132 may generate and present user interfaces to a user via a display of the client system 130. For example, the client application 132 may generate and present user interfaces, as depicted in at least FIGS. 7, 8A-8D, 9A-9E, 11A-11C, 12A-12C, and 13-16, based at least in part on information received from the gaming platform 140 or the social-networking system 160 via the network 110.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using the client application 132, which may be a web browser or a native application associated with the social-networking system 160 (e.g., a mobile social-networking application, another suitable application, or any combination thereof) either directly or via a network 110.

In particular embodiments, the social-networking system 160 may include a social network server 162. The social network server 162 may be a computing device for managing the online social network hosted on the social-networking system 160. The server 162 may be a unitary server or a distributed server spanning multiple computers or multiple datacenters. In particular embodiments, the social network server 162 may include hardware, software, or embedded logic components or a combination of two or more such components for carrying out the appropriate functionalities implemented or supported by server 162. Although a single social network server 162 is shown, it should be noted that this is not by any way limiting and this disclosure contemplates any number of social network servers 162.

In particular embodiments, the social-networking system 160 may include a data store 164. The data store 164 may be used to store various types of information. In particular embodiments, the information stored in the data store 164 may be organized according to specific data structures. In particular embodiments, the data store 164 may be a relational, columnar, correlation, or other suitable database. Although this disclosure describes or illustrates particular types of databases, this disclosure contemplates any suitable types of databases. Particular embodiments may provide interfaces that enable a client system 130, a gaming platform 140, a social-networking system 160, a third-party system 170, a messaging system 180, or a game-managing system 190 to manage, retrieve, modify, add, or delete, the information stored in the data store 164.

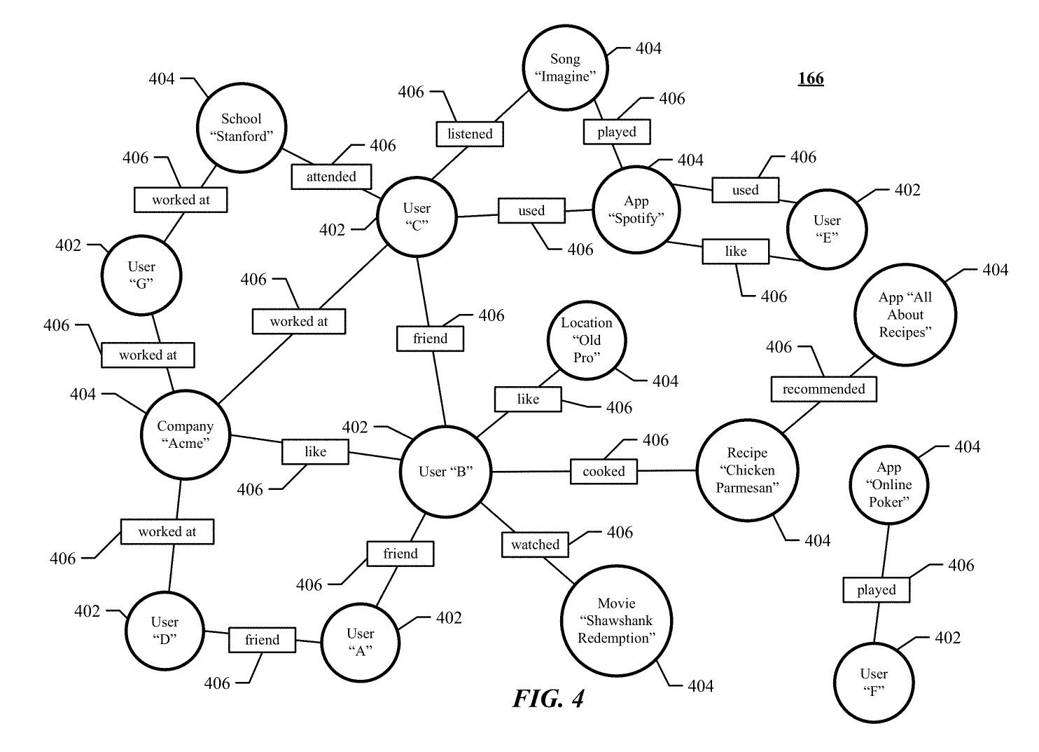

In particular embodiments, the social-networking system 160 may store a social graph 166 in the data store 164. In particular embodiments, a social graph 166 may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160. The social graph 166 is discussed in further detail below in reference to at least FIG. 4.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from the gaming platform 140, the third-party system 170, the messaging system 180, or the game-managing system 190, or to allow users to interact with these entities through an application programming interface (API) or other communication channels. As depicted, the social-networking system 160 may include a plurality of application programming interfaces (APIs) 168a through 168n (individually and/or collectively herein referred to as 168). An API is set of routines, protocols, and tools by which the social-networking system 160 may be able to communicate with one or more other entities of the network environment 100. In some embodiments, an API may be defined for each application associated with the social-networking system 160. For example, API 168a may be a social-networking application API, 168b may be a social-graph API, 168c may be a sharing-moments API, API 168d may be a choose-context API, API 168e may be a connected-player API, so on and so forth. In some embodiments, an API may be defined by one or more developers associated with the social-networking system 160. In some embodiments, an API of the social-networking system 160 may be sent to one or more other entities of the network environment 100 (e.g., via an API handler 202) that may enable them to add one or more additional features to the existing API of the social-networking system 160.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the gaming platform 140, the social-networking system 160, the messaging system 180, or the game-managing system 190. In particular embodiments, one or more of the gaming platform 140, the social-networking system 160, the messaging system 180, or the game-managing system 190, and the third-party system 170 may operate in conjunction with each other to provide various services/functionalities to users. For example, the social-networking system 160 and the third-party system 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof.

In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external).

A web server may be used for linking the social-networking system 160 to one or more of the client system 130, the gaming platform 140, the third-party system 170, the messaging system 180, or the game-managing system 190 via a network 110. The web server may include a mail server or other messaging functionality for receiving and routing messages between the social-networking system 160 and one or more client systems 130. An API-request server may allow a gaming platform 140, a third-party system 170, a messaging system 180, and/or a game-managing system 190 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

In particular embodiments, the messaging system 180 may be a network-addressable computing system that can host an online messaging network. The messaging system 180 may enable users to interact with each other via a messaging application that they can access through their client systems 130. The messaging system 180 may allow a user to send/receive messages, watch videos, share images, play games, etc. with other users connected to the online messaging network. The messaging system 180 may be accessed by one or more entities of the network environment 100 either directly or via the network 110. As an example and not by way of limitation, a client system 130 may access the messaging system 180 using the client application 132, which may be a native application associated with the messaging system (e.g., a messaging application), either directly or via the network 110.

In some embodiments, the messaging system 180 and the social-networking system 160 may operate in conjunction with each other to provide messaging services discussed herein to users of the messaging system 180. In this sense, the social-networking system 160 may provide a platform, or backbone, which the messaging system 180 may use to provide messaging services and functionalities to users across the online messaging network. In some embodiments, the messaging system 180 and the social-networking system 160 may be combined into one single entity and that entity may be responsible for providing the various social-networking and messaging services/functionalities to users across the Internet. For example, a single entity may include the various elements/components of the social-networking system 160 and the messaging system 180, such as a social network server 162, a message server 182, a data store (including a social graph 166 and gamer graph 186), APIs 168a through 168n, and APIs 188a through 1888n. In some embodiments, the messaging system 180 and the social-networking system 160 may be linked to each other via one or more APIs. For example, the messaging system 180 or the social-networking system 160 may call an API of the other entity to host or provide service(s) associated with the other entity in its own environment. In some embodiments, the messaging system 180 and the social-networking system 160 may operate as independent entities and may communicate with one another via the network 110 as depicted in FIG. 1. It should be noted that various other configurations by which the various entities of the network environment 100 may interact with each other are possible and is within the scope of the present disclosure.

In particular embodiments, the messaging system 180 may include a message server 182. The message server 182 may be a computing device for managing the messaging network and associated services/functionalities hosted on the messaging system 180. The message server may include hardware, software, or embedded logic components or a combination of two or more components for carrying out the appropriate functions or processes discussed herein. Although the messaging system 180 is shown here to be including a single message server 182, it should be noted that this is not by any way limiting and this disclosure contemplates any number of message servers 182.

In particular embodiments, the messaging system 180 may include a data store 184. The data store 184 may be used to store various types of information. In particular embodiments, the information stored in the data store 184 may be organized according to specific data structures. In particular embodiments, the data store 184 may be a relational, columnar, correlation, or other suitable database. Although this disclosure describes or illustrates particular types of databases, this disclosure contemplates any suitable types of databases. Particular embodiments may provide interfaces that enable a client system 130, a gaming platform 140, a social-networking system 160, a game-managing system 190 and/or a third-party system 170 to manage, retrieve, modify, add, or delete, the information stored in data store 184. Although a single data store 184 is shown as being associated with the messaging system 180, it should be noted that this is not by any way limiting and this disclosure contemplates any number of data stores 184.

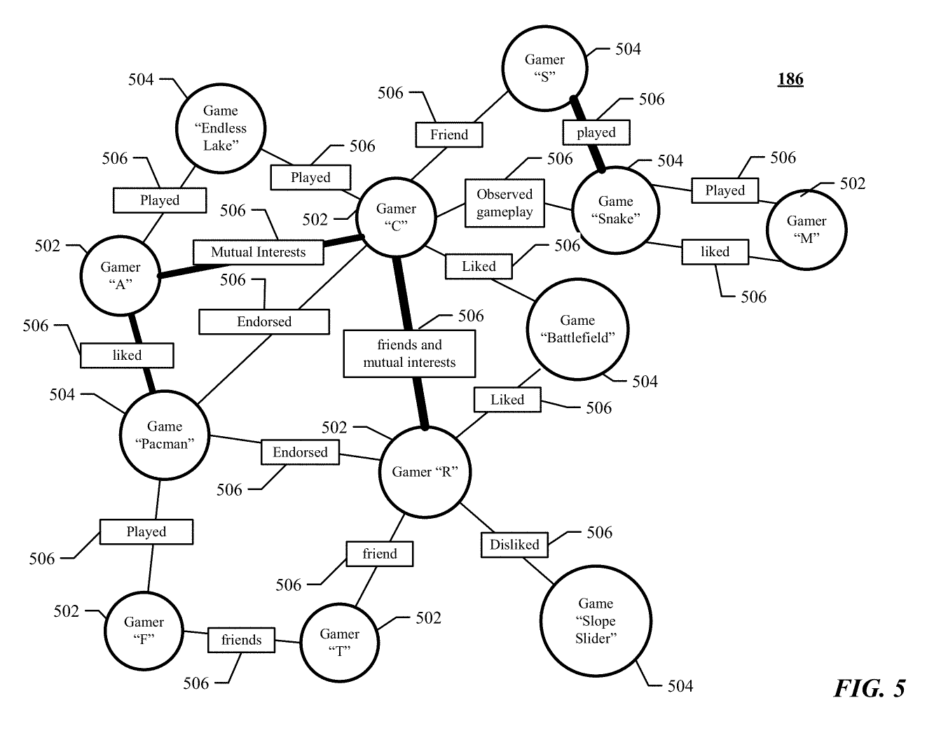

In particular embodiments, the messaging system 180 may store a gamer graph 186 in the data store 184. In particular embodiments, the gamer graph 186 may include multiple nodes—which may include multiple gamer nodes or multiple game nodes—and multiple edges connecting the nodes. The gamer graph 186 may be used to determine a “game affinity” for a first user with respect to a second user based on the degree-of-separation within the graph, as well as other interactions, such as user frequency of interaction with a game, with other users, etc. The “game affinity” and these other interactions may be used to suggest one or more games to a user and/or suggest one or more other users/players for game challenges or invites. The gamer graph 186 is discussed in further detail below in reference to at least FIG. 5.

In particular embodiments, the messaging system 180 may include a plurality of application programming interfaces (APIs) 188a through 188n (individually and/or collectively herein referred to as 188). An API 188 may enable the messaging system 180 to communicate with one or more other entities of the network environment 100. For example, using API(s) 188, the messaging system 180 may be able to send data to and/or receive data from the gaming platform 140, the social-networking system 160, the game-managing system 190, or the third-party system 170. In some embodiments, an API may be defined for each application associated with the messaging system 180. For example, API 188a may be a messaging application API, 188b may be a gamer graph API, etc. In some embodiments, an API may be defined by one or more developers associated with the messaging system 180. In some embodiments, an API of the messaging system 180 may be sent to one or more other entities of the network environment 100 that may enable them to add one or more additional features to an existing API of the messaging system 180. As an example and not by way of limitation, a messaging application API of the messaging system 180 may be provided to a game developer associated with the game-managing system 190 to add one or more game relating features to the messaging application.

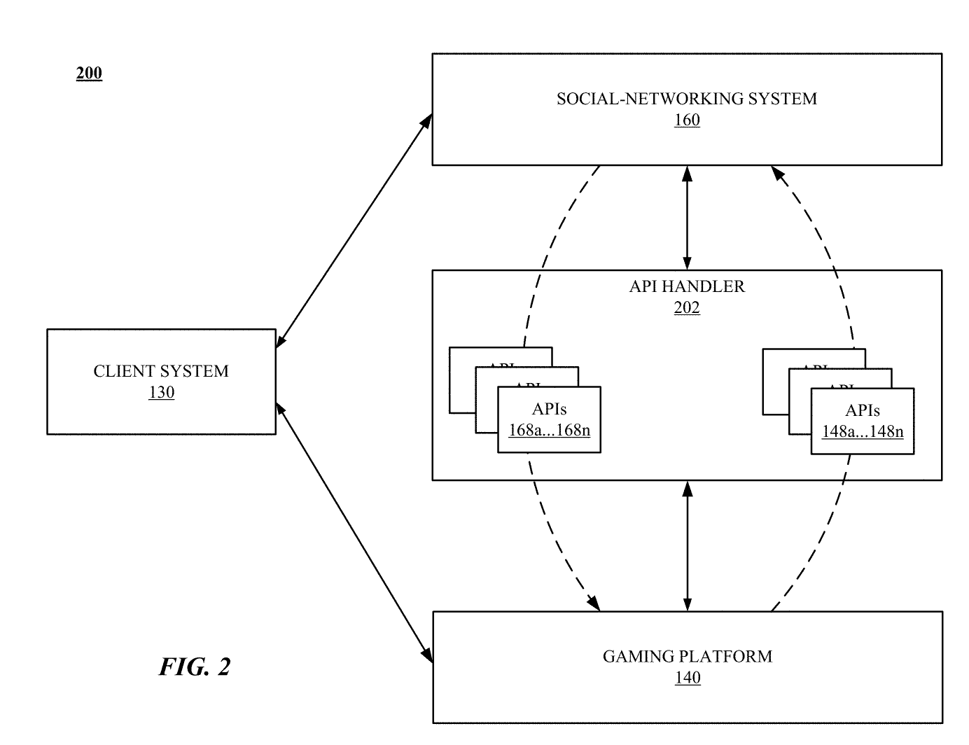

In particular embodiments, the game-managing system 190 may be a network-addressable computing system that can host an online gaming network. For instance, the game-managing system 190 may enable users across the Internet to play a variety of games with each other or individually. The game-managing system 190 may be accessed by one or more entities of the network environment 100 either directly or via the network 110. As an example and not by way of limitation, the messaging system 180 may access the game-managing system 190 by way of one or more APIs (e.g., API calls). API calls may be handled by an API hander, such as an API handler 202 shown in FIG. 2.

In particular embodiments, the game-managing system 190 may include a game server 192. The game server 192 may be a computing device for managing the online gaming network hosted on and associated services/functionalities provided by the messaging system 190. The game server 192 may include hardware, software, or embedded logic components or a combination of two or more components for carrying out the appropriate functions or processes discussed herein. Although a single game server 192 is shown here, it should be noted that this is not by any way limiting and this disclosure contemplates any number of game servers 192.

In particular embodiments, the game-managing system 190 may include a game library 194. The game library 194 may include a plurality of online games that may be hosted on the game server 192. The game library 194 may include games categorized and/or grouped by their respective genres. For example, the game library 194 may include games grouped by action, adventure, racing, puzzle, etc. In some embodiments, the game library 194 is a data store that is accessible and/or modifiable by the game server 192. For instance, the game server 192 may be able to manage, retrieve, modify, add, or delete, the information stored in game library 194.

In particular embodiments, the game-managing system 190 may include a plurality of application programming interfaces (APIs) 198a through 198n (individually and/or collectively herein referred to as 198). An API 198 may enable the game-managing system 190 to communicate with one or more other entities of the network environment 100. For example, using API(s) 198, the game-managing system 190 may be able to send data to and/or receive data from the gaming platform 140, the social-networking system 160, the third-party system 170, or the messaging system 180. In some embodiments, an API may be defined for each application associated with the game-managing system 190. For example, API 198a may be a games API, 198b may be a leaderborad API, 198c may be a gamer-profile API, etc. In some embodiments, an API may be defined by a game developer associated with the game-managing system 190. In some embodiments, an API of the game-managing system 190 may be sent to one or more other entities of the network environment 100 that may enable them to add one or more additional features to the existing API. As an example and not by way of limitation, a games API of the game-managing system 190 may be provided to the social-networking 160 for it to integrate games as part of its online social network.

The gaming platform 140 is a platform for hosting one or more games that a user can engage in playing. For instance, the gaming platform 140 may enable users to play a variety of games with each other or individually. The gaming platform 140 may be accessed by one or more entities of the network environment 100 either directly or via the network 110. As an example and not by way of limitation, the client system 130 may access the gaming platform 140 via the network 110 or by an API call.

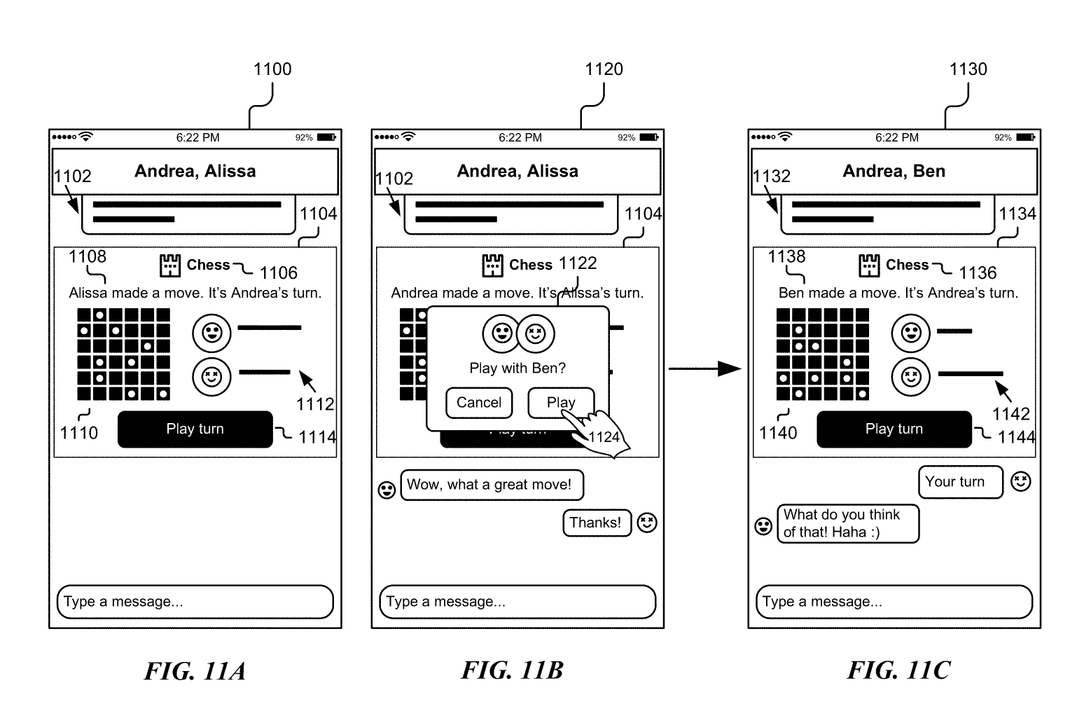

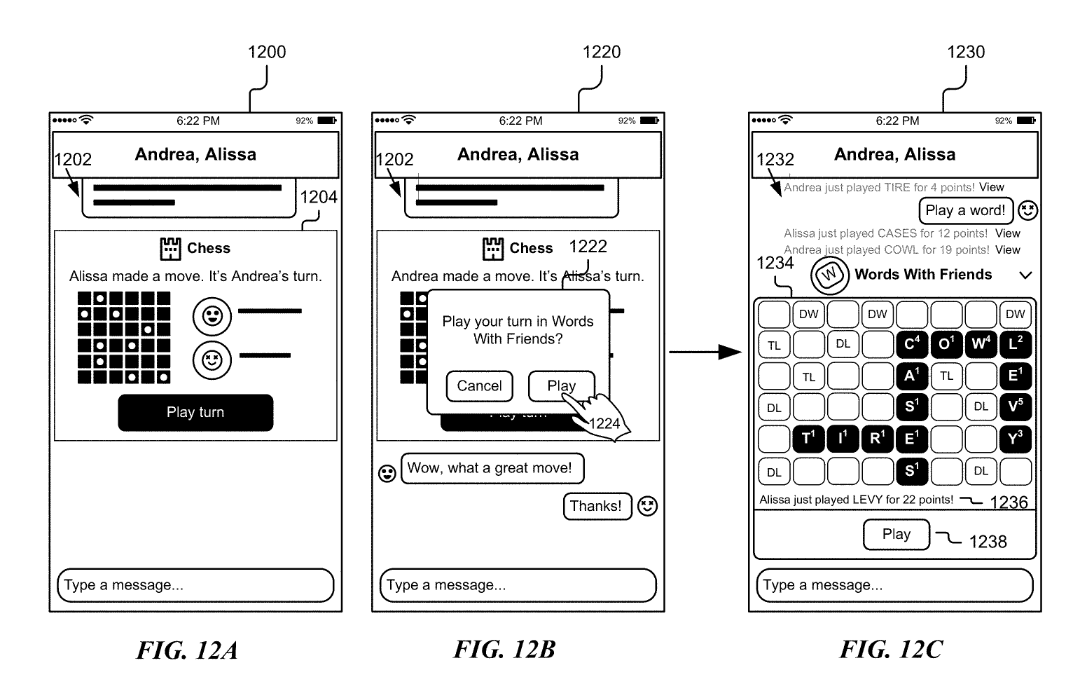

In particular embodiments, the gaming platform 140 may be one of a web-based gaming platform that may be located on and is part of an online social network itself (e.g., see FIG. 7) accessible through a web browser, a desktop-based gaming platform that may integrate one or more social-networking features of the online social network and may be running as a dedicated or standalone application on the client system 130 of a user, or a messaging-application-based gaming platform (also interchangeably referred to sometimes as a mobile platform or a mobile-based gaming platform) that may be integrated into a messaging application of the online social network where users may be able to play games with their social contacts via the messaging application. For example, a user may play a game with another user within a message thread of the messaging application (e.g., see FIG. 11C and FIG. 12C) (each of these platforms discussed in detail below).

In particular embodiments, the gaming platform 190 may include a plurality of application programming interfaces (APIs) 148a through 148n (individually and/or collectively herein referred to as 148). An API 148 may enable the gaming platform 140 to communicate with one or more other entities of the network environment 100. For example, using API(s) 148, the gaming platform 140 may be able to send data to and/or receive data from the client system 130, the social-networking system 160, the third-party system 170, the messaging system 180, or the game-managing system 190. In some embodiments, the gaming platform 140 and the game-managing system 190 may operate in conjunction with each other to provide gaming services discussed herein to users of the gaming platform 140. In some embodiments, the gaming platform 140 and the game-managing system 190 may be combined into one single entity and that entity may be responsible for providing the various gaming services/functionalities to users across the Internet. For example, a single entity may include the various elements/components of the gaming platform 140 and the game-managing system 190, such as a gamer server 192, a game library 194, APIs 148a through 148n, and APIs 198a through 198n. In some embodiments, the gaming platform 140 and the game-managing system 190 may be linked to each other via one or more APIs. For example, the gaming platform 140 or the game-managing system 190 may call an API of the other entity to host or provide service(s) associated with the other entity in its own environment. In some embodiments, the gaming platform 140 and the game-managing system 190 may operate as independent entities and may communicate with one another via the network 110 as depicted in FIG. 1.

In connection with network environments for online games, particular embodiments may utilize one or more systems, components, elements, functions, methods, operations, or steps disclosed in U.S. patent application Ser. No. 15/475,801, filed 31 Mar. 2017, which is incorporated by reference.

FIG. 2 is a block diagram illustrating an example environment 200 in which a client system 130, a social-networking system 160, and a gaming platform 140 may interact with each other. The client system 130 may be connected to the social-networking system 160 and/or the gaming platform 140 via the network 110 (e.g., internet). In particular embodiments, the client system 130 may access functionalities provided by the social-networking system 160 and/or the gaming platform 140 via a client application 132. For example, the client application 132 may be a social-networking application running on the client system 130 and connected to the social network server 162 via the network 110 to enable access to one or more social-networking features (e.g., newsfeed, games, messaging, photos, videos, etc.). As another example, the client application 132 may be a gaming-platform application running on the client system 130 and connected to a gaming platform server (not shown) via the network 110 to enable access to one or more games hosted on the gaming platform 140. In some embodiments, the client system 130 may access the gaming platform 140 via the social-networking system 160, as discussed elsewhere herein.

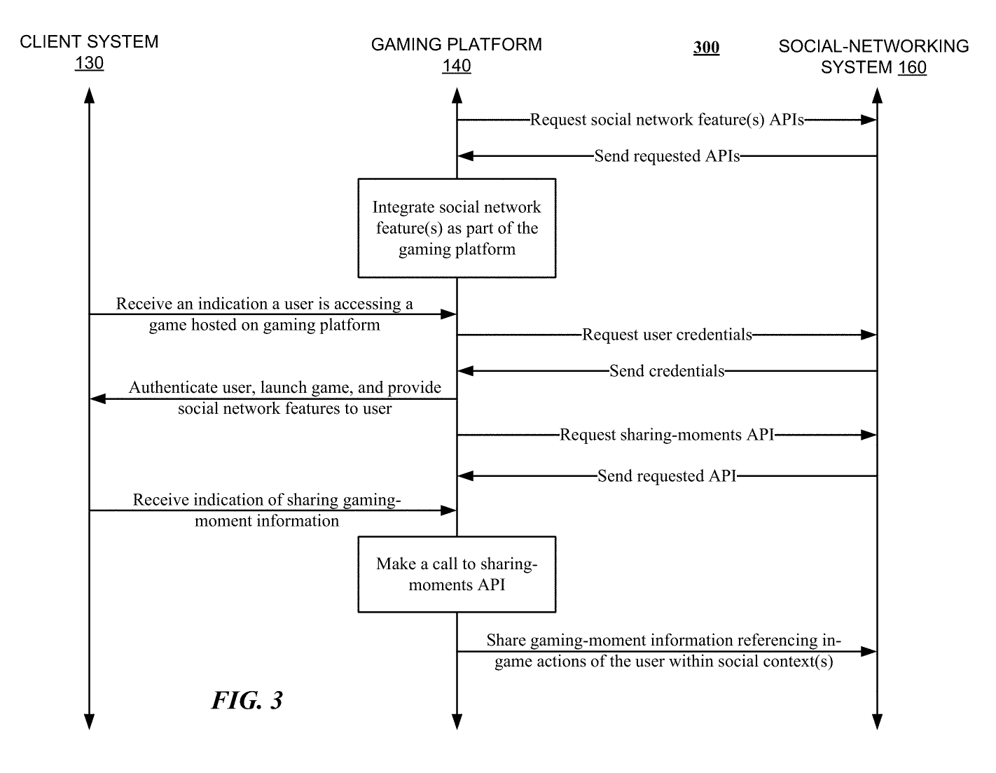

In particular embodiments, the social-networking system 160 and the gaming platform 140 may interact with each other via APIs. For instance, the social-networking system 160 may send one or more of its APIs 168 to and/or receive one or more of the APIs 148 from the gaming platform 140. Similarly, the gaming platform 140 may send one or more of its APIs 148 to and/or receive one or more of the APIs 168 from the social-networking system 160. One example embodiment of API(s) transfer is shown and discussed in detail in reference to FIG. 3. The transfer of APIs or API calls may be handled by an API handler 202. The API handler 202 is a software, logic, and/or routine for handling API requests/calls from one entity to another. For example, the API handler 202 may receive a request from the gaming platform 140 for an API 168 of the social-networking system 160. The API handler 202 may transfer the request to the social-networking system 160 and in response receive the requested API and then send that API to the gaming platform 140 to fulfil the request. Similarly, the API handler 202 may handle a request for an API associated with the gaming platform 140 from the social-networking system 160. As another example, the API handler 202 may enable the social-networking system 160 and the gaming platform 140 to access functionalities of one another by handling API calls between the two parties.

FIG. 3 is example interaction/flow diagram 300 illustrating example interactions between a client system 130, a gaming platform 140, and a social-networking system 160. In particular, the interaction/flow diagram 300 shows one exemplary way by which the gaming platform 140 requests one or more APIs from the social-networking system 160 and provide one or more services to a user of the client system 130 via the one or more APIs. It should be noted that the interaction/flow diagram 300 shown in FIG. 3 is for exemplary purposes only and is not by any way limited to these interactions. A variety of other interactions are also possible between these entities and is within the scope of the present disclosure.

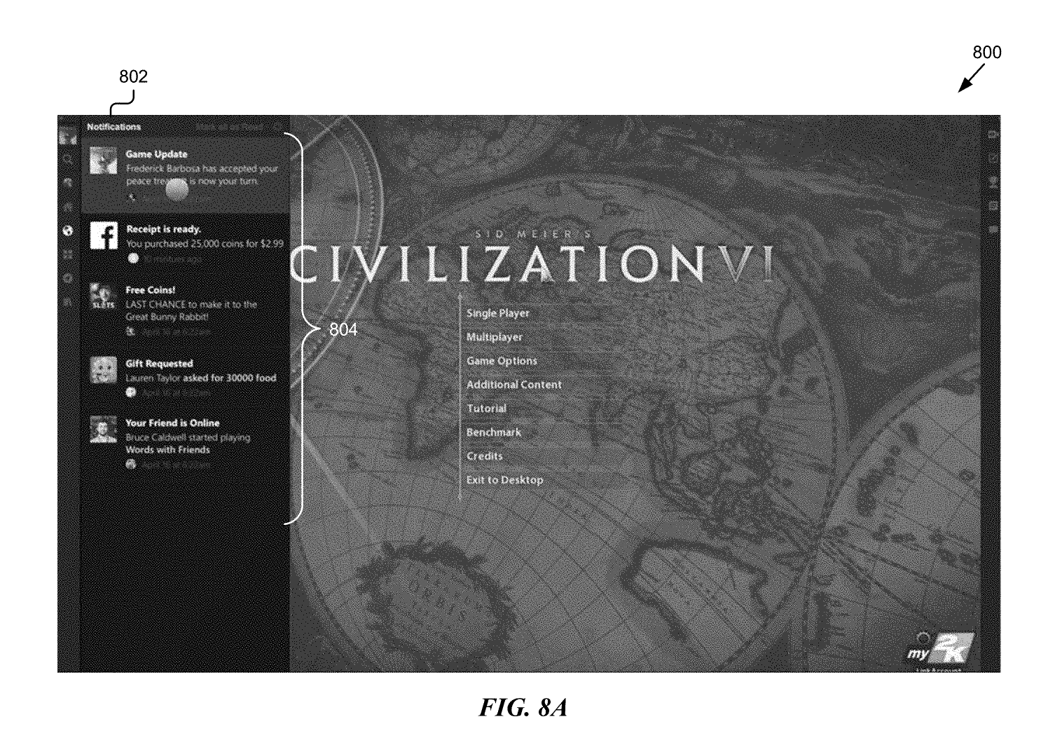

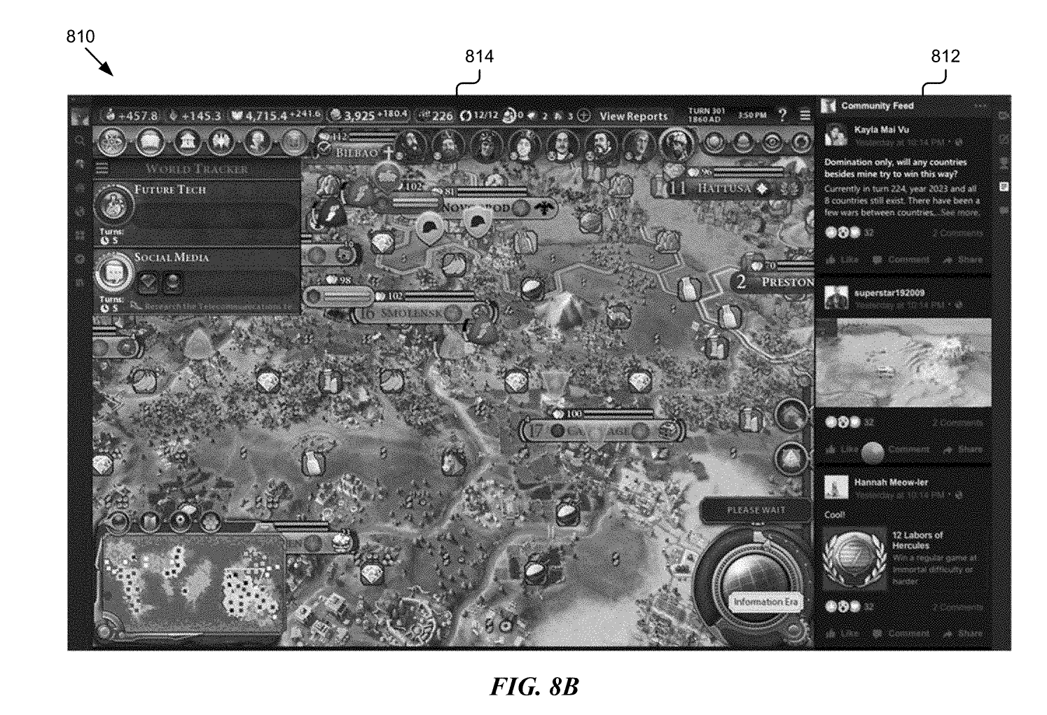

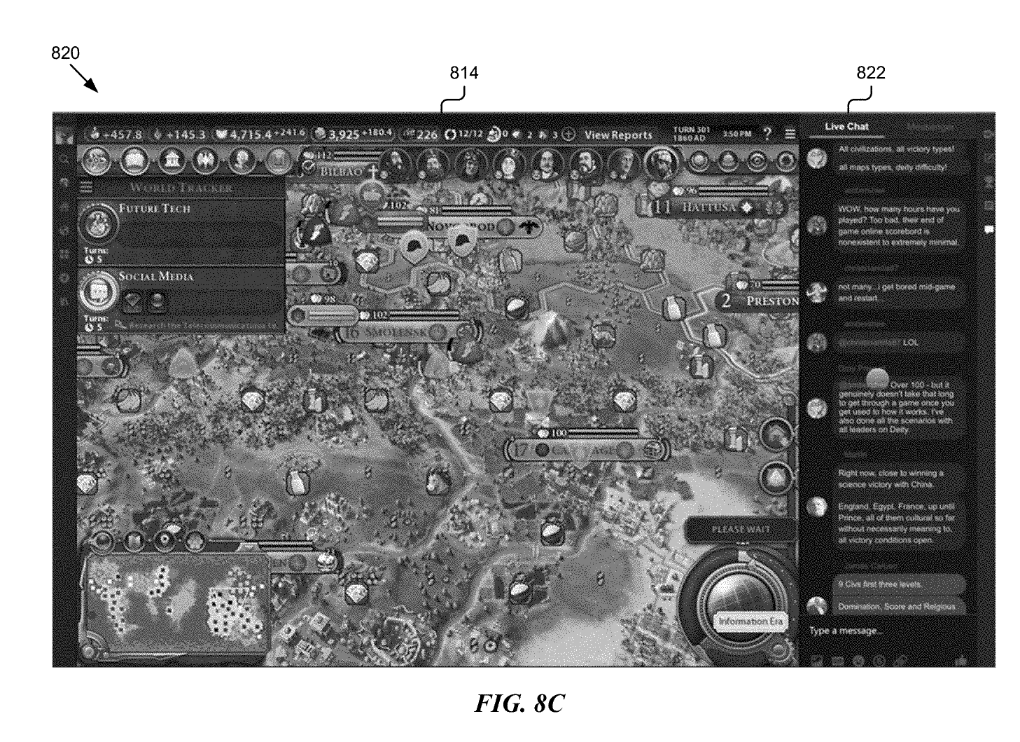

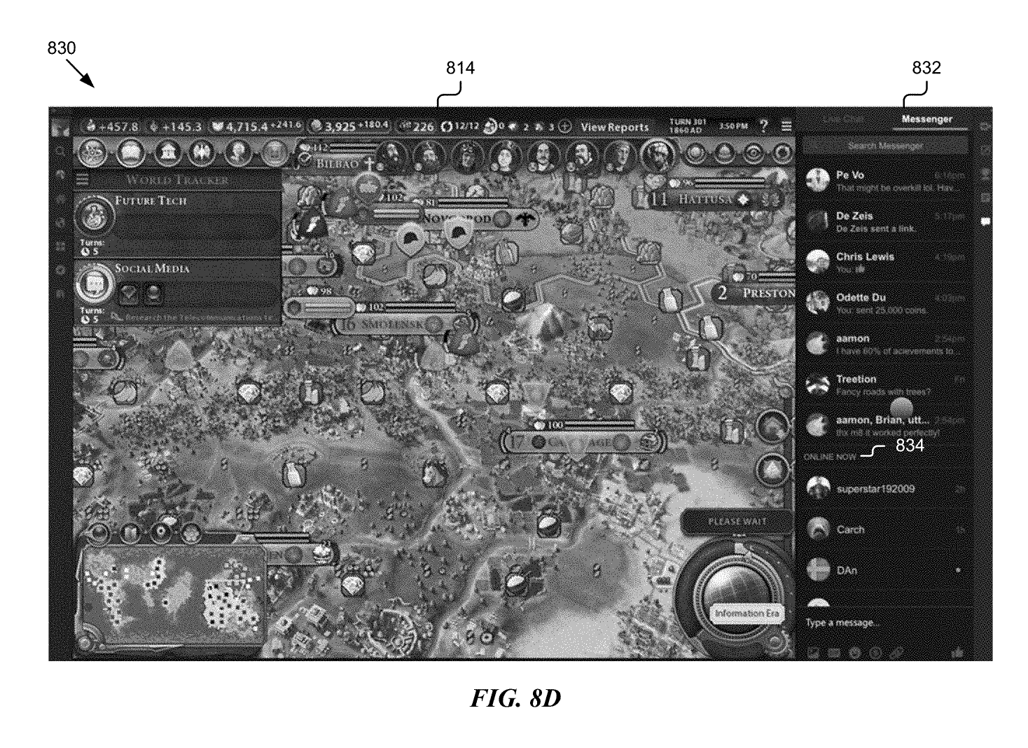

As depicted in FIG. 3, the gaming platform 140 requests one or more social network-feature APIs from the social-networking system 160. For example, the gaming platform 140 may request a newsfeed API (for integrating a live media feed where people can post media content as shown in FIG. 8B), a messaging API (for integrating a messaging application for exchanging messages/chats between two or more users as shown in FIG. 8D), etc. Upon receiving the request, the social-networking system 160 looks for the requested APIs from a plurality of APIs 168 stored in a data store (e.g., the data store 164) and provide the requested APIs to the gaming platform 140. The gaming platform 140 may integrate the requested APIs as part of its gaming environment such that users of the gaming platform may be able to access social-networking features in addition to playing games within the gaming platform 140. For example, by integrating social network features APIs as part of the gaming platform 140, a user of the gaming platform 140 may be able to receive various notifications associated with an online social network (e.g., as shown in FIG. 8A), access and post content to a community/newsfeed (e.g., as shown in FIG. 8B), engage in a live chat conversation with other users (e.g., as shown in FIG. 8C), access and/or send messages to specific group(s) or individual users via a messaging application (e.g., as shown in FIG. 8D), etc. A user may be able to access one or more games and one or more social-network features discussed herein via a client application 132 on their client system 130. As discussed elsewhere herein, the one or more games may be hosted by the gaming platform 140. As depicted, the gaming platform 140 may receive an indication from the client system 130 that the user is accessing a particular game. Upon receiving the indication, the gaming platform 140 may authenticate the user access to the gaming platform 140 to play the game via a single sign-on experience in cooperation with the social-networking system 160. For example, the gaming platform 140 may request user login credentials (e.g., username, password, etc.) from the social-networking system 160. The social-networking system 160, upon receiving the request, send the requested credentials with which the user is registered at the social-networking system 160 to the gaming platform 140. Using the credentials, the gaming platform 140 may authenticate the user, launch the game for the user, and in addition provide one or more social-network features that it integrated using the social-network feature(s) APIs discussed herein.

In addition to the social-network feature(s) APIs, the gaming platform 140 may request a sharing-moments API from the social-networking system 160. Similar to the social-network feature(s) APIs, the social-networking system 160 looks for the sharing-moments API from plurality of APIs 168 stored in a data store and provides its sharing-moments API to the gaming platform 140. The sharing-moments API may enable the gaming platform 140 to share or provide gaming-moment information on one or more social contexts within the online social network. The gaming-moment information may include references to one or more in-game actions of the user of the client system 130 in the particular game and metadata associated with each of the one or more in-game actions. At some point in time, the gaming platform 140 may receive an indication from the client system 130 that the user wants to share gaming-moment information on the one or more social contexts. Upon receiving the indication, the gaming platform 140, via a call to the sharing-moments API, share gaming-moment information referencing in-game actions of the user on the one or more social contexts requested by the user. For example, the gaming platform 140 may share in-game highlights, game screenshots, user achievements, user gameplays, etc. on a personal gamefeed space of the user and/or specific user groups on the online social network of the social-networking system 160.

### Social Graphs

FIG. 4 illustrates an example social graph 166. In particular embodiments, the social-networking system 160 may store one or more social graphs 166 in one or more data stores. In particular embodiments, the social graph 166 may include multiple nodes—which may include multiple user nodes 402 or multiple concept nodes 404—and multiple edges 406 connecting the nodes. The example social graph 166 illustrated in FIG. 4 is shown, for didactic purposes, in a two-dimensional visual map representation. In particular embodiments, a gaming platform 140, a social-networking system 160, a client system 130, a third-party system 170, a messaging system 180, or a game-managing system 190 may access the social graph 166 and related social-graph information for suitable applications. The nodes and edges of the social graph 166 may be stored as data objects, for example, in a data store (such as a social-graph database). Such a data store may include one or more searchable or queryable indexes of nodes or edges of the social graph 166.

In particular embodiments, a user node 402 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 402 corresponding to the user, and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with the social-networking system 160. In particular embodiments, a user node 402 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more web interfaces.

In particular embodiments, a concept node 404 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 404 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 404 may be associated with one or more data objects corresponding to information associated with concept node 404. In particular embodiments, a concept node 404 may correspond to one or more web interfaces.

In particular embodiments, a node in the social graph 166 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 404. Profile interfaces may be viewable by all or a selected subset of other users. As an example and not by way of limitation, a user node 402 may have a corresponding user-profile interface in which the corresponding user may add content, make declarations, or otherwise express himself or herself. As another example and not by way of limitation, a concept node 404 may have a corresponding concept-profile interface in which one or more users may add content, make declarations, or express themselves, particularly in relation to the concept corresponding to concept node 404.

In particular embodiments, a concept node 404 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 402 corresponding to the user and a concept node 404 corresponding to the third-party web interface or resource and store edge 406 in one or more data stores.

In particular embodiments, a pair of nodes in the social graph 166 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 406 connecting the first user's user node 402 to the second user's user node 402 in the social graph 166 and store edge 406 as social-graph information in one or more of data stores 164. In the example of FIG. 4, the social graph 166 includes an edge 406 indicating a friend relation between user nodes 402 of user “A” and user “B” and an edge indicating a friend relation between user nodes 402 of user “C” and user “B.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 166 by one or more edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to an edge type or subtype. A concept-profile interface corresponding to a concept node 404 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 406 and a “used” edge (as illustrated in FIG. 4) between user nodes 402 corresponding to the user and concept nodes 404 corresponding to the song and application to indicate that the user listened to the song and used the application. Moreover, the social-networking system 160 may create a “played” edge 406 (as illustrated in FIG. 4) between concept nodes 404 corresponding to the song and the application to indicate that the particular song was played by the particular application. In this case, “played” edge 406 corresponds to an action performed by an external application (SPOTIFY) on an external audio file (the song “Imagine”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “E” and concept node 404 for “SPOTIFY”).

In particular embodiments, the social-networking system 160 may create an edge 406 between a user node 402 and a concept node 404 in the social graph 166. As an example and not by way of limitation, a user viewing a concept-profile interface (such as, for example, by using a web browser or a special-purpose application hosted by the user's client system 130) may indicate that he or she likes the concept represented by the concept node 404 by clicking or selecting a “Like” icon, which may cause the user's client system 130 to send to the social-networking system 160 a message indicating the user's liking of the concept associated with the concept-profile interface. In response to the message, the social-networking system 160 may create an edge 406 between user node 402 associated with the user and concept node 404, as illustrated by “like” edge 406 between the user and concept node 404. In particular embodiments, the social-networking system 160 may store an edge 406 in one or more data stores. In particular embodiments, an edge 406 may be automatically formed by the social-networking system 160 in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

### Gamer Graphs

FIG. 5 illustrates an example gamer graph 186. In particular embodiments, the gamer graph 186 may include multiple nodes—which may include multiple gamer nodes 502 or multiple game nodes 504—and multiple edges 506 connecting the nodes. The gamer graph may be used to determine a “game affinity” for a first player with respect to a second player based on the degree-of-separation within the graph, as well as other interactions, such as player frequency of interaction with a game, with other players, etc. The “game affinity” and these other interactions may be used to suggest one or more games to a user and/or suggest one or more other users/players for game challenges or invites. The example gamer graph 186 illustrated in FIG. 5 is shown, for didactic purposes, in a two-dimensional visual map representation. In particular embodiments, gaming platform 140, a social-networking system 160, a client system 130, a third-party system 170, or a game-managing system 190 may access the gamer graph 186 and related information for suitable applications. The nodes and edges of the gamer graph 186 may be stored as data objects, for example, in a data store (such as a gamer-graph database). Such a data store may include one or more searchable or queryable indexes of nodes or edges of the gamer graph 186.

In particular embodiments, a gamer node 502 may correspond to a gamer of the messaging system 180. As an example and not by way of limitation, a gamer may be a user who is involved with one or more games and/or game-related activity on the gaming platform 140. In particular embodiments, when a user interacts with a game and/or perform a game-related activity (e.g., like a game, share a game with friends, challenge friends in a game, send/receive game invites, etc.) on the gaming platform 140, the gaming platform 140 may create a gamer node 502 corresponding to the user, and store the gamer node 502 in one or more data stores.

In particular embodiments, a game node 504 may correspond to a game. As an example and not by way of limitation, a game node may correspond to a “Pacman” game, “Battlefield” game, “Snake” game, “Slope Slider” game, “Batman” game, “Mario” game, “Tetris” game, “Scrabble” game, “Chess”, “EverWing” game, etc. In some embodiments, the gaming platform 140 may create different game nodes 504 when one or more gamers interacts with one or more games. In some embodiments, the gaming platform 140 may create game nodes by accessing a game library from a game-managing system 190 and then creating a node for each game.

In particular embodiments, a pair of nodes in the gamer graph 186 may be connected to each other by one or more edges 506. An edge 506 connecting a pair of nodes may represent a relationship between the pair of nodes. In particular embodiments, an edge 506 between a gamer node 502 and a game node 504 may represent a particular action or activity performed by a gamer toward a game. As an example and not by way of limitation, once user “A” associated with the game node 502 played the game “Endless Cake” associated with the game node 504, the gaming platform 140 may create an edge 506 “played” (which may be referred to as a played-type edge 506) between the two nodes to indicate that “A” interacted with the game. As another example, user “R” associated with the gamer node 502 endorsed the “Pacman” game associated with the game node 504 on his newsfeed, the gaming platform 140 may create an edge 506 “Endorsed” (an endorsed-type edge 506) to indicate the gamer's activity toward that game.

In particular embodiments, different type of edges may be used to indicate a certain degree of relationship or separation between two nodes. A degree of relationship between two gamer nodes is an indicator of gamer affinity of a first gamer with respect to a second gamer. For example, the bolded edges between two gamer nodes in the gamer graph 186 may represent a strong gamer affinity between the two players. By way of example, the edge 506 between the gamer node of “C” and the gamer node of “R” indicates a very strong gamer affinity between the two gamers as they have mutual interests for the games as well as they are also friends. As another example, the edge 506 between the gamer node of “C” and the gamer node of “A” indicates a fairly strong gamer affinity between the two gamers as they also have mutual interests for the games but they may or may not be friends.

In particular embodiments, different edge types may also be used to indicate a certain degree of relationship between a gamer node and a game node. This degree of relationship between a game and a gamer may be useful to determine a player likeness/preference towards the game or frequency of interaction with that game. For example, a bolded edge between the gamer node of “S” and the game node of “Snake” may indicate that the a frequency of interaction of gamer “S” with “Snake” game is relatively higher than other games which may be an indicator of user certain degree of preference towards this game.

### Gaming Moments and Groups

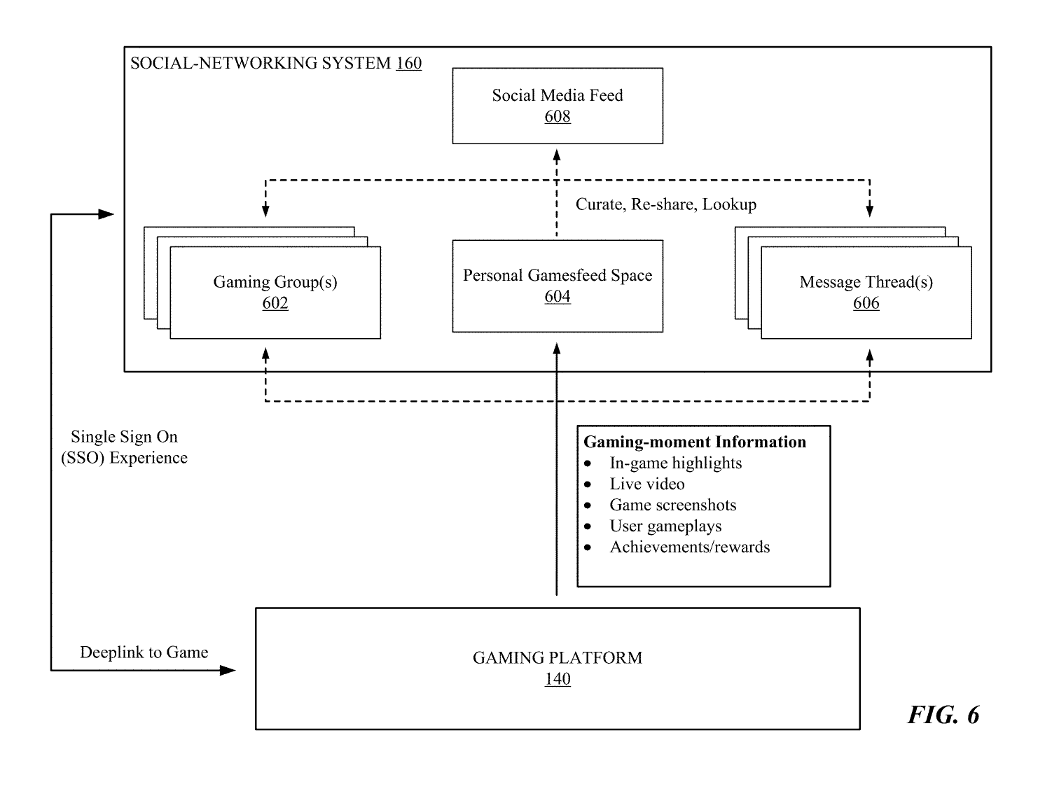

In particular embodiments, the social-networking system 160 may share gaming-moment information with one or more social-contexts on an online social network. The gaming-moment information may include references to one or more in-game actions of user in a game. For example, the gaming-moment information may include, as an example and not by way of limitation, in-game highlights, game screenshots, live media streams, user achievements, user gameplays, etc. The social-networking system 160 may share the gaming-moment information on one or more social contexts. The one or more social contexts may include a user's personal gamefeed space, one or more gaming groups, one or more message threads of a messaging application of the online social network, and/or a social media feed or newsfeed space on the online social network. The social-networking system 160 may receive the gaming-moment information from a gaming platform 140. The gaming platform 140 may host one or more games that the user can play. The gaming platform may be one of a web-based gaming platform that may be located on and is part of the online social network itself, a desktop-based gaming platform that may integrate one or more social-networking features of the online social network, or a messaging-application-based or a mobile-based gaming platform that may be integrated into a messaging application of the online social network. Using the mobile-based gaming platform, a user may be able to play games with one or more other users (e.g., social contacts) via the messaging application. In particular embodiments, the gaming platform may authenticate the user to play a game via a single sign on (SSO) process in cooperation with the social-networking system 160. For example, the gaming platform may receive user login credentials (e.g., username, password) from the social-networking system 160 and use that to authenticate the user and provide access to the game. In particular embodiments, the social-networking system 160 may receive the in-game moment information from the gaming platform 140 via a sharing-moments API (discussed more below). For example, upon receiving a request, the social-networking system 160 may provide the sharing-moments API to the gaming platform 140 (e.g., see FIG. 3), which may then call this API to send gaming-moment information to the social-networking system 160. Gaming-moment information may be shared for different game types or game genres. For example, gaming-moment information may be shared for a solo/single-player game (i.e., where a user is playing a game by himself); a multi-player game (i.e., where two or more users play the game with or against each other); a competitive multi-player game (i.e., where two or more players play the game against each other), a collaborative/cooperative multi-player game (i.e., where two or more player are playing together to finish a game); a turn-based game (i.e., where one or more players take actions in turn); a real-time/live-action game (i.e., where one or more players continuous play over time); or other suitable types of games. Specific details on how the social-networking system 160 receive gaming-moment information from the gaming platform 140 and share the information on social contexts are discussed below in reference to FIG. 6.

FIG. 6 is an interaction diagram showing an example interaction between a gaming platform 140 and a social-networking system 160 regarding sharing of gaming-moment information on social contexts within an online social network. The gaming platform 140 is a platform that may host a plurality of games that a user can play or otherwise engage with. For example, the gaming platform 140 may provide a game library containing the plurality of games to a user and the user can choose a desired game to play. There may be several ways that the user may access the gaming platform 140. As an example, the user may access the gaming platform 140 via the social-networking system 160. For instance, the gaming platform 140 may be a web-based platform that may be integrated as part of the online social network of the social-networking system 160. Links to various games may be present at some location on the online social network and the user may click on a particular game that may launch the gaming platform 140 hosting that particular game within a web browser on the client system 130 of the user.

FIG. 7 is a user interface 700 that shows accessing the gaming platform 140 from within an online social network (e.g., Facebook). As depicted in the interface, shortcuts 702 to various games 704 are provided within the interface 700. A user may select a desired game 704a to play by clicking or tapping on it (as indicated by reference numeral 706). Upon receiving the user game selection, a launch window 708 may be shown within the interface 700 indicating that the selected game will be automatically launched in the gaming platform 140 for playing (as shown by a status indicator 710). In particular embodiments, a user may access the gaming platform 140 via a dedicated application present on the client system 130 of the user. For instance, the application may be a gaming-platform application installed on the client system 130 of the user and the user may click on the application to access the gaming platform 140 and play a game. In this instance, the gaming platform 140 is a desktop-based gaming platform. In some embodiments, the desktop-based gaming platform may integrate one or more features of the online social network (discussed in further detail below). For example, the gaming platform 140 may contain a social-notification window (see FIG. 8A), a live community feed (see FIG. 8B), a live-chat window (see FIG. 8C), and a social messenger (see FIG. 8D). In particular embodiments, a user may access the gaming platform 140 through a messaging application of the online social network. For instance, the messaging application may include a dedicated games tab comprising a list of games from which the user may select a desired game for playing (as discussed in detail in U.S. patent application Ser. No. 15/783,885, filed 13 Oct. 2017, hereby incorporated by reference in its entirety). The user can play the game, alone or with other user(s), from inside a message thread of the messaging application (as discussed in detail in U.S. patent application Ser. No. 15/783,905, filed 13 Oct. 2017, hereby incorporated by reference in its entirety). In this instance, the gaming platform 140 is a messaging-application-based or a mobile-based gaming platform, which is integrated into the messaging application of the online social network.

In particular embodiments, the social-networking system 160 may authenticate the user access to the gaming platform 140 to play a game via a single sign-on feature. The social-networking system 160 may receive a request from the gaming platform 140 for login credentials (e.g., username, password) of the user associated with the online social network. In response to the request, the social-networking system 160 may provide the user's login credentials to the gaming platform 140, which may use then use to automatically authenticate the user (i.e., without requiring manual user input) for playing the game on the gaming platform 140. As an example and not by way of limitation, in a web-based gaming platform (integrated as part of the online social network) where the user is already signed-in into the online social network, the social-networking system 160 may seamlessly authenticate the user access to the gaming platform 140 by providing the user authentication/validation details to the gaming platform 140 in the background. In some embodiments, the gaming platform 140 may explicitly request the user to provide the login credentials. For example, when the user is not signed into the online social network, the gaming platform 140 may request the user to provide his authentication details associated with the online social network. In some embodiments, when the user is logging into the gaming platform 140 for the first time, the gaming platform 140 may ask the user to create/sign-up for an account to get access into the platform 140 to play games. In certain embodiments, when the user is explicitly asked to provide the authentication details, the gaming platform 140 may provide options to the user to sign-in either via the login credentials associated with the gaming-platform account itself or the login credentials associated with the online social network.

In particular embodiments, upon receiving a request, the social-networking system 160 may provide one or more of its social-network-features APIs to the gaming platform 140, which may use these APIs to integrate one or more social network features in its gaming environment, as discussed in reference to FIG. 3. As an example and not by way of limitation, the gaming platform 140 may request the social-networking system 160 to provide its newsfeed API, messenger API, and social-notifications API and upon receiving the requested APIs, the gaming platform 140 may integrate social-network features corresponding to these APIs in its gaming environment, as shown and discussed in reference to FIGS. 8A-8D below.

FIGS. 8A-8D are user interfaces showing various example social network features within the gaming platform 140. In particular, FIG. 8A is a user interface 800 showing an example social-notifications window 802 within the gaming platform 140. The social-notifications window 802 may include one or more notifications 804 relating to social updates on the online social network of the social-networking system 160 and/or relating to the current game being played on the gaming platform 140. A social update may include, as an example and not by way of limitation, an activity relating to a user of the online social network (e.g., the user posted a comment, the user posted a media content (photo/video), the user is online, etc.). In particular embodiments, the gaming platform 140 may integrate these social updates as part of its platform via the social-notifications API, as discussed elsewhere herein. Having the social-notifications window 802 within the gaming platform 140 is advantageous as the user may not want to miss any important social updates while he is engaged in playing the game and may return to the online social network at any time upon identifying an important update/notification in the social-notifications window 802. In some embodiments, the user may click on a notification to go directly into the context with which the notification is associated. For example, if the notification is that a user's friend has posted a photo on the online social network, then the user may click on this notification to go directly into the newsfeed of the online social network where the photo has been posted to view it or put any comments. FIG. 8B is a user interface 810 showing an example community feed 812 within the gaming platform 140. The community feed 812 may include game-related posts from people relating to the game 814 currently being played on the gaming platform 140 and/or social-network posts from user contacts (e.g., friends) and other users on the online social network. In particular embodiments, the gaming platform 140 may integrate these social-network posts as part of its platform via the newsfeed API, as discussed elsewhere herein. Having the community feed 812 within the gaming platform 140 is advantageous as the user may follow other user activities relating to the game 814 and/or the online social network while simultaneously playing the game 814 within the gaming platform 140. FIG. 8C is a user interface 820 showing an example live-chat window 822 within the gaming platform 140. The user of the gaming platform 140 may use the live-chat window 822 to chat in real-time with other users who are currently engaged in or have been involved with the game 814. For example, the game 814 may be a co-op/collaborative game where five users are playing together. Using the live-chat window 822, each of these users may exchange messages to plan a next move, a specific game strategy to take down the opponent, etc. FIG. 8D is a user interface 830 showing an example social messenger 832 within the gaming platform 140. The social messenger 832 may include user contacts (e.g., friends) and specific groups that the user has created, is part of, or has subscribed to on the online social network. The social contacts may be displayed in the order of recency. In some embodiments, the users who are currently online on the online social network may be displayed in a separate section in the messenger 832, as shown for example in the “ONLINE NOW” section 834. In particular embodiments, the gaming platform 140 may integrate the messenger 832 as part of its platform via the messenger API, as discussed elsewhere herein. Having the messenger 832 within the gaming platform 140 is advantageous as the user of the gaming platform 140 may constantly be in touch with his friends on the online social network while playing the game 814 and may further invite one or more friends to come join and play the game 814 with the user.

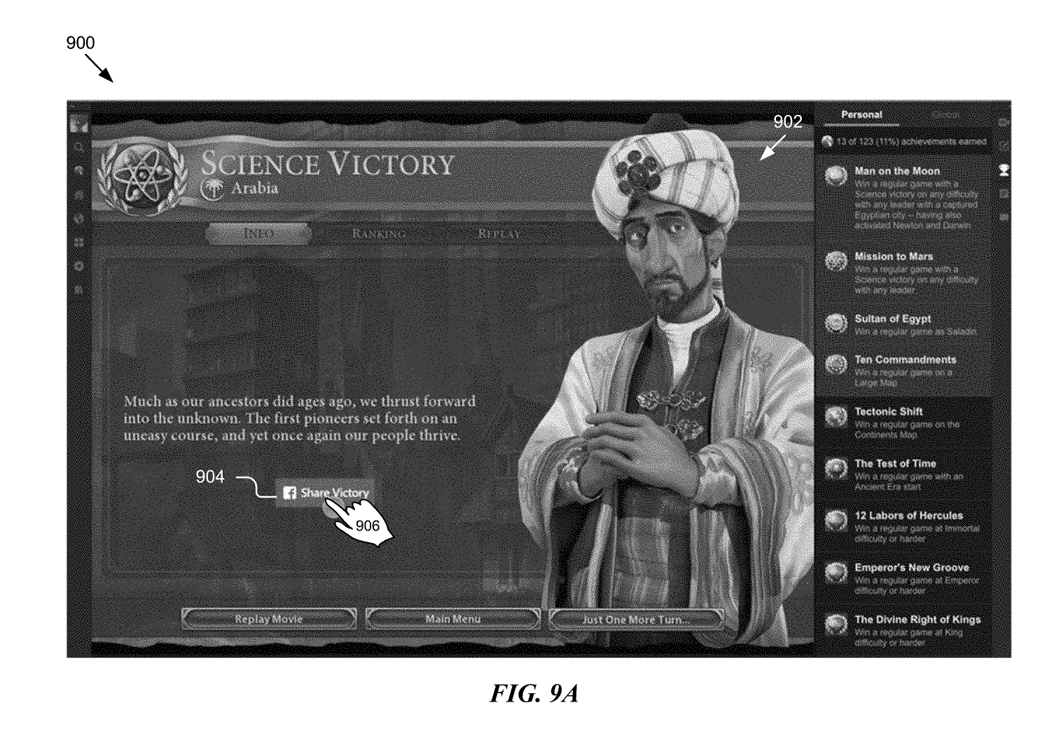

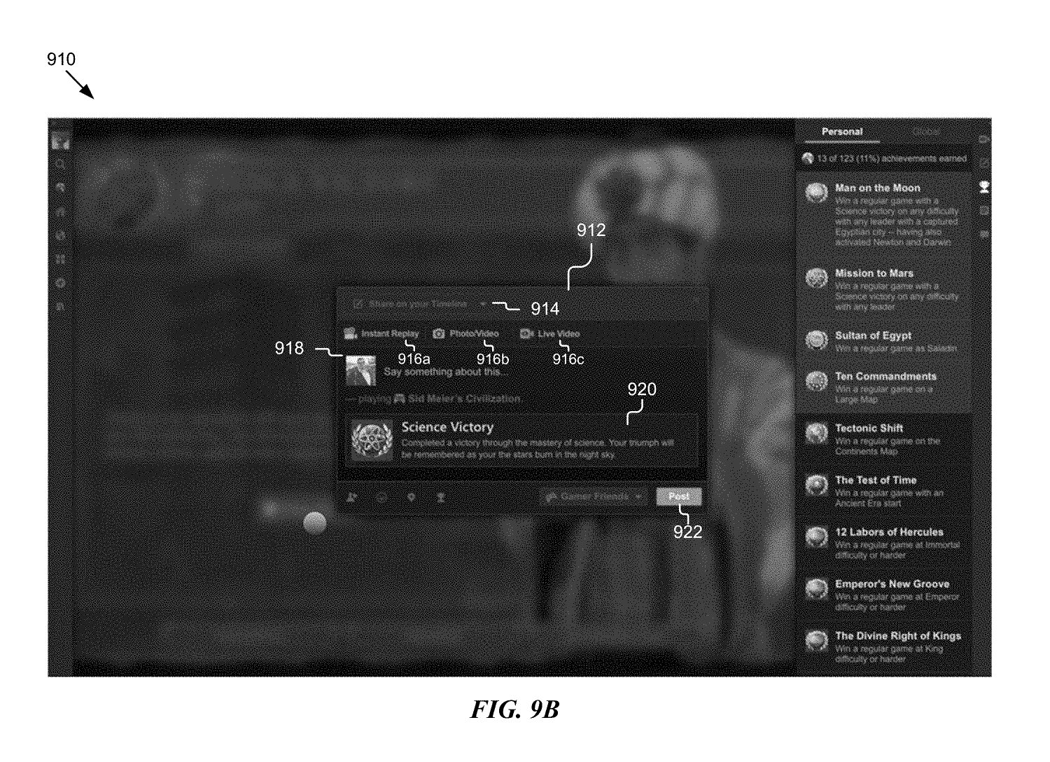

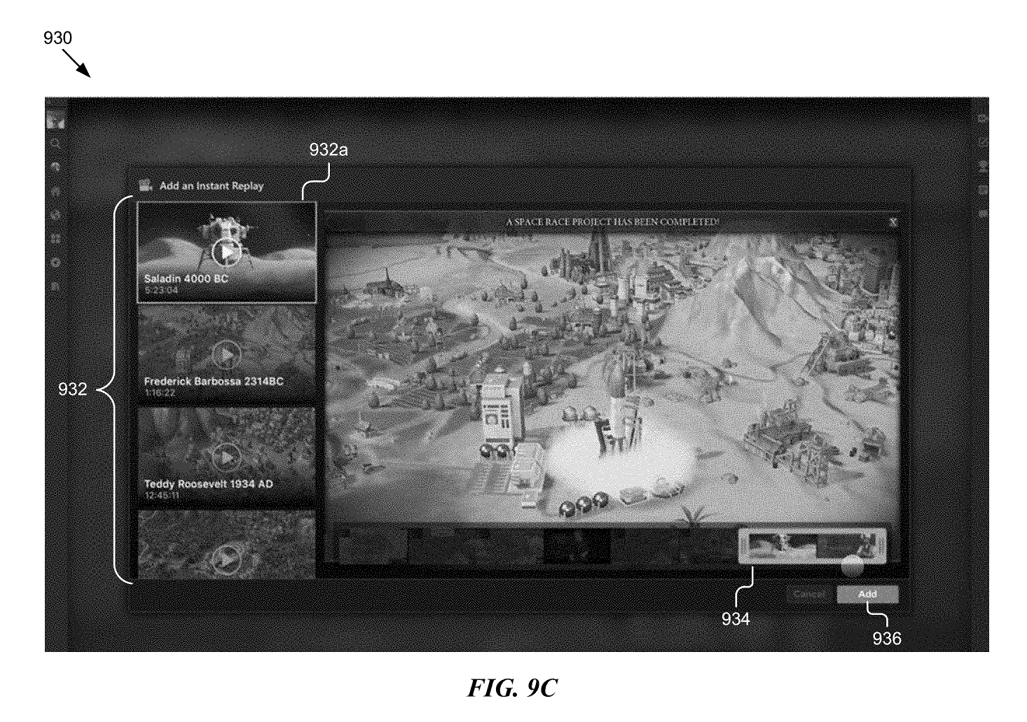

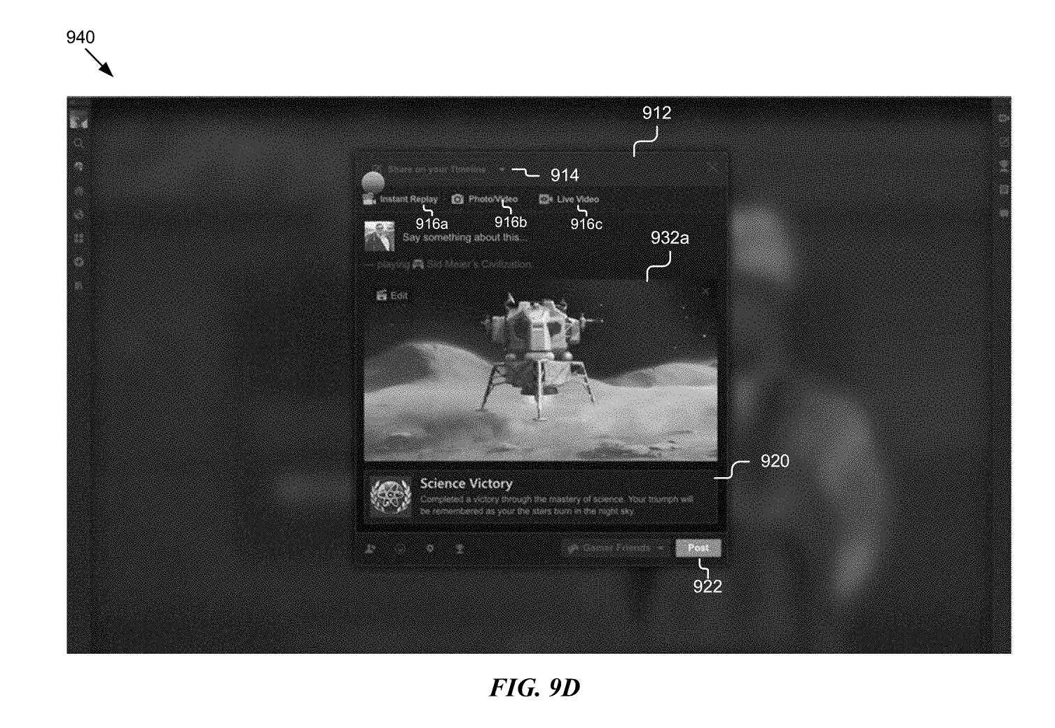

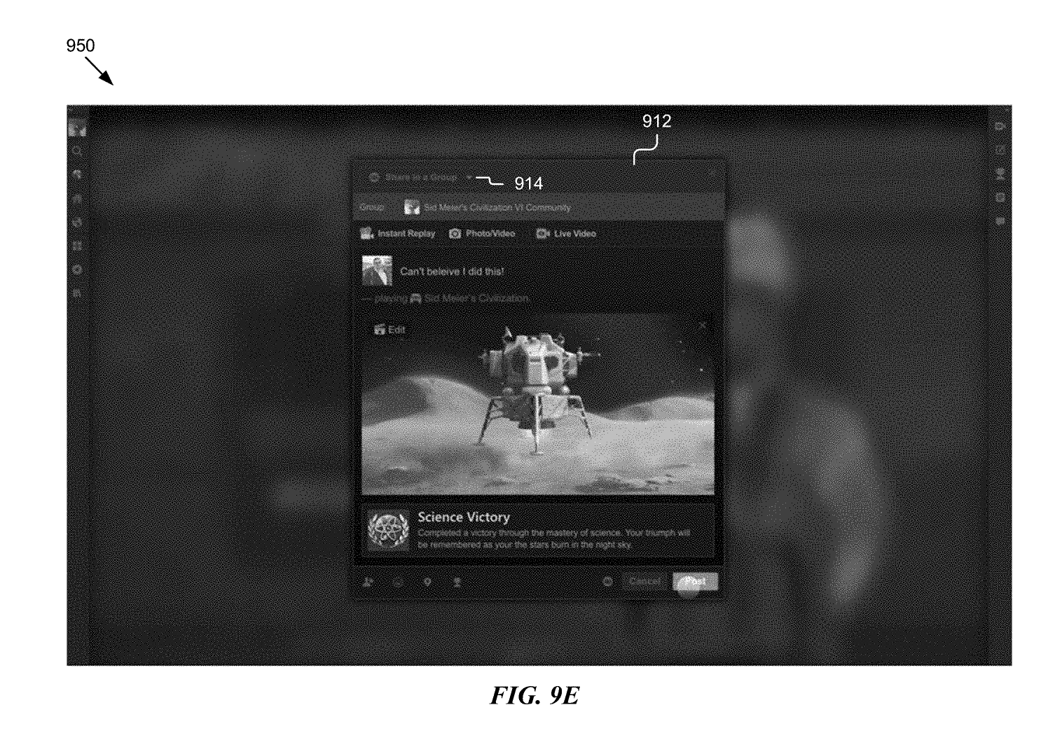

In particular embodiments, in response to a request, the social-networking system 160 may provide a sharing-moments API to the gaming platform 140, as shown and discussed in reference to FIG. 3. The gaming platform 140 may use the sharing-moments API to send gaming-moment information to the social-networking system 160, which may further share on one or more social contexts within the online social network (as discussed in detail later below). In some embodiments, the software code, logic, and/or instructions associated with the sharing-moments API may be incorporated into a game itself. For instance, the social-networking system 160 may share, upon request, the sharing-moments API as a binary library with game developers who may then integrate this library into a binary of their game. Depending on a user's in-game action (e.g., user defeated a boss, user achieved a new high score, user unlocked a new level, user rewarded with a prize, etc.), the game may automatically present a sharing dialogue (e.g., as shown in FIGS. 9A and 9B) for sharing a gaming moment referencing the user in-game on one or more social contexts within the online social network. In particular embodiments, when a user is playing or has played a game on the gaming platform 140, the gaming platform 140 may capture gaming-moment information via a gaming-moments API. The gaming-moments API comprises a set of instructions (defined by the social-networking system 160) that when executed enables the gaming platform 140 to capture gaming-moment information and corresponding metadata associated with in-game action(s) of a user. The gaming-moment information may include references to one or more in-game actions or activities of the user (also sometimes interchangeably referred to herein as gaming moments) inside the game hosted on the gaming platform 140. As an example and not by way of limitation, the gaming-moment information may include in-game highlights (such as a small video clip showing the user fight with the boss at a particular game level), user gameplays showing in-game action of the user at certain time intervals during the game, live or real-time game video as the user is playing the game, game screenshots (e.g., in-game photos) at certain time durations, achievements/rewards/prizes collected by the user during the game, etc. In particular embodiments, in addition to the gaming-moment information, the gaming platform 140 may capture metadata associated with in-game actions of the user. For example, the metadata may include user performance metrics (e.g., scores, ranks) in the game, game progression information (e.g., how much is the game completed or how far the user has made into the game, such as the game is 60% complete), game leaderboard showing the performance metrics of the user relative to other users associated with the same game, user achievement data (e.g., rewards/prizes, unlocks, status, recognitions achieved by the user in the game), social-connection information of the user (e.g., other users to which the user is connected within the online social network along with degree of separation information for each of the users), etc. In particular embodiments, the gaming platform 140 may timestamp the metadata (e.g., user performance metrics/statistics, game progression statistics) at the time of capturing. For example, if the gaming platform 140 captures a gaming moment when a user achieved a rank 1 in a particular game, then the date, time, and/or day of achievement may be recorded and associated with the captured gaming moment. As another example, when a user hits an all time high score while playing the game then this may be timestamped (e.g., specific time or point in the game at which the user hit the high score) and incorporated into or associated with a gaming moment information (e.g., in-game video). In this example, assuming that the gaming-moment information is a 5:00 minute in-game video and user hit the high score at 2:51 during the video then indication of this may be timestamped so that when someone watches this in-game video, they may scroll directly to the point at the which user achieved the high score in the game.

In some embodiments, the gaming platform 140 may automatically capture gaming-moment information and corresponding metadata via the gaming-moments API at periodic time intervals. As an example and not by way of limitation, the gaming platform 140 may be configured to capture user gameplay, in-game screenshot, and achievement data of the user at every 15 minutes of the game. In some embodiments, the gaming platform 140 via the gaming-moments API may automatically capture the gaming-moment information and corresponding metadata when the in-game action or activity of the user satisfy certain criteria. As an example and not by way of limitation, the gaming platform 140 may capture a gaming moment when the user has unlocked a new level, the user has received a certain in-game reward or benefit, the user's current game status or level has reached to the next level, the user defeated a particular game opponent, the user's score reached above a certain threshold score, or at other suitable in-game milestones. In some embodiments, when a user is playing a game, the gaming-moments API may be constantly capturing an in-game video of the user's gameplay (e.g., from start of the game until the user pauses or finishes the game) in the background. When an in-game action or activity of the user satisfy certain criteria (as discussed above) then a part of the captured in-game video representing that in-game action may be generated from the full in-game video for sharing on the one or more social contexts. As an example and not by way of limitation, if the user defeated a big boss at a particular level in a game, then the gaming platform 140, via the gaming-moments API, may analyze the captured complete in-game video (e.g., video including the entire user gameplay from start of the game until the current game state) to generate a sub video showing only the user fight with the big boss from the start until the defeat of the boss or user victory for sharing. In some embodiments, the gaming platform 140, via the gaming-moments API, may not capture the entire in-game video and may only capture the last N minutes of the game. For example, only the last 5 minutes of the user gameplay may be captured and saved in memory for later sharing.

In particular embodiments, once the gaming platform 140 has captured the gaming-moment information and corresponding metadata, the gaming platform 140 may send them to the social-networking system 160 by making a call to the sharing-moments API. In addition to the gaming-moment information and corresponding metadata, the gaming platform 140 may include instructions regarding one or more social contexts (e.g., personal gamefeed space 604 of the user, one or more gaming groups 602, one or more message threads 606 of a messaging application, and a social media feed 608) on which the gaming-moment information and corresponding metadata be shared. In a default configuration (in order to protect user privacy), the gaming platform 140 may include instructions to share the gaming-moment information and corresponding metadata only on the personal gamefeed space 604 of the user from where the user may decide if he wants to further share one or more in-game actions on other social contexts 602, 606, and/or 608. In some embodiments, the gaming platform 140 may include instructions to simultaneously share the gaming-moment information and corresponding metadata on all the social contexts 602-608 within the online social network. In some embodiments, the user of the gaming platform 140 may be able to configure the privacy settings in the gaming platform 140 relating to the sharing of the gaming-moment information on one or more social contexts 602-608 according to his preference and the gaming platform may include instructions for sharing on the one or more social contexts 602-608 according to the user preference.

In some embodiments, the gaming platform 140 may make a call to the sharing-moments API for sending gaming-moment information to the social-networking system 160 in real-time. For instance, when the gaming platform 140 captures an in-game action or gaming moment, the gaming platform 140 may call the sharing-moments API to send that gaming moment to the social-networking system 160 for sharing on one or more social contexts 602-608. In some embodiments, the gaming platform 140 may make a call to the sharing-moments API once a predetermined number of gaming moments have been captured. As an example and not by way of limitation, the gaming platform 140 calls the sharing-moments API once three or more gaming moments have been captured. In this example, when the gaming platform 140 captures a first gaming moment of user unlocking a new level, a second gaming moment of user achieving a game prize, and a third gaming moment of user setting a new all-time high score, the gaming platform 140 calls the sharing-moments API to send these three gaming moments to the social-networking system 160 for sharing. In some embodiments, the gaming platform 140 may make a call to the sharing-moments API for sending one or more in-game actions or gaming moments to the social-networking system 160 in response to receiving an explicit sharing request from the user of the gaming platform 140, as shown and discussed in reference to FIGS. 9A-9E. For instance, the gaming platform 140 may present a captured gaming moment to the user along with an option if the user wants to share this gaming moment (e.g., see FIG. 9A). The user may edit the gaming moment and decide on a social context on which he wants the gaming moment to be shared (e.g., FIGS. 9B-9E). Once the user is done making any edits to the gaming moment and deciding on a desired social context, the user may provide a posting or sharing confirmation. Upon receiving the confirmation from the user, the gaming platform 140 may make a call to the sharing-moments API to send the edited gaming moment to the social-networking system 160 along with instructions to share the gaming moment on the user selected social context. Sharing of gaming moment(s) upon receiving explicit share request from user is discussed in detail below in reference to FIGS. 9A-9E.

FIGS. 9A-9E are user interfaces showing an example sharing of a gaming moment on a social context within an online social network. In particular, FIG. 9A is a user interface 900 showing an example gaming moment 902 and a sharing option element 904 for sharing the gaming moment 902 on a social context. The gaming moment 902 here shows a “SCIENCE VICTORY” that a user of the gaming platform 140 has achieved in the “CIVILIZATION” game. In particular embodiments, FIG. 9A is generated by the gaming platform 140 when it captures the gaming moment 902. The user interface 900 is presented on the client system 130 of the user. The user may select the sharing option element 904 by clicking or tapping on it (as indicated by reference numeral 906). Upon receiving user selection, the gaming platform 140 may present a user interface 910 (see FIG. 9B) on the client system 130 of the user. The user interface 910 of FIG. 9B shows an example sharing window 912. The sharing window 912 includes a social-context selection drop-down menu 914 for selecting a desired social context on which the user wants to share the gaming moment 902, one or more attachment options 916a-916c for attaching content (e.g., instant replay 916a, photo/video 916b, or a live video 916c) to the gaming moment 902, a comment section 918 for inserting a comment regarding the gaming moment 902, a gaming-moment-preview window 920 showing a preview or screenshot of the gaming moment 902, and a “POST” button 922 for posting the gaming moment 902 along with any comments and content on the chosen social context. As mentioned elsewhere herein, by default, a social context is set to a user personal space on the online social network or a timeline, as indicated in the social-context selection drop-down menu 914. The user may select a different social context using the drop-down menu 914. For example, the user may choose to share a gaming moment on his timeline, in a gaming group, in a message thread, in a social-media or news feed, etc. As an example and not by way of limitation, the user may choose to share the gaming moment 902 in a group, as shown in the social-context selection drop-down menu 914 in a user interface 950 of FIG. 9E. FIG. 9C is a user interface 930 that shows adding content to a gaming moment using the one or more attachment options 916a-916 (discussed in FIG. 9B). In particular embodiments, the gaming platform 140 may present the interface 930 when the user selects the “Instant Replay” attachment option 916a in the interface 910 of FIG. 9B. The user interface 930 shows various instant replays 932, which may be in-game videos at different time intervals. The user may select a desired instant replay 932a to add to the gaming moment 902. The user may edit the instance replay 932a before adding to the gaming moment 902. For example, the instant replay 932a may be a one minute in-game video and the user may choose to add only the last fifteen seconds of the video, as indicated by the selection window 934. Once the user is done editing the instant replay 932a, the user may add it to the gaming moment 902 by clicking on the “Add” action button 936. Once the user clicks on the “Add” button 936, the gaming platform 140 may generate a user interface 940 (see FIG. 9D). The interface 940 of FIG. 9D shows the sharing window 912 with the instant replay 932a added to the gaming moment 902. FIG. 9E is a user interface 950 showing the social-context selection drop-down menu 914 set to a different social context (e.g., for sharing the gaming moment 902 in a group instead of user timeline as shown in FIG. 9B). Once the user is done selecting a desired social context, putting any comments, and attaching one or more content items to the gaming moment 902, the user may share them on the selected social context by clicking on the “Post” button 922. As mentioned elsewhere herein, in response to receiving a sharing or posting confirmation from the user, the gaming platform 140 may make a call to the sharing-moments API to send the gaming moment 902 (along with any user provided comment and/or content) to the social-networking system 160 for sharing on the user-selected social context.

In particular embodiments, the social-networking system 160 may receive gaming-moment information including one or more in-game actions or gaming moments and corresponding metadata from the gaming platform 140. As mentioned elsewhere herein, the gaming platform 140 may provide instructions to the social-networking 160 regarding which social contexts 602-608 the gaming-moment information be shared. The social-networking system 160 may share the one or more gaming moments based on these instructions. As an example and not by way of limitation, the instructions may indicate sharing the one or more gaming moments only on the personal gamefeed space 604 of the user (in order to protect user privacy). As another example and not by way of limitations, the instructions may indicate sharing the one or more gaming moments on all social contexts 602-608 within the online social network including one or more gaming groups 602, the personal gamefeed space 604 of the user, one or more message threads 606, and a social media feed 608.

The personal gamefeed space 604 may be a private space allotted to a first user on the online social network where game-related content (e.g., posts, photos, videos, user gameplays, in-game highlights, game screenshots, messages, game achievements, etc.) are posted for user review. Only the first user of the personal gamefeed space 604 have access to the content and may later decide to share content with other second users of the online social network. For example, the first user can share content on one or more gaming groups 602, in one or more message threads 606, and/or newsfeed or the social media feed 608. A gaming group 602 may be a group comprising the first user and one or more seconds users of the online social network. In this group, the first user and the one or more second users may exchange messages and share game-related content. Each of the gaming groups 602 may be specific to a particular game. For example, a first gaming group 602 may be a “CIVILIZATION” gaming group where the first user and other second users share content relating to this game in the group, a second gaming group 604 may be a “EVERWING” gaming group where content specific to this game is shared and/or exchanged between the group members, etc. In some embodiments, the one or more gaming groups 604 may be defined by the first user. For example, the first user may create a gaming group 604 and send requests to one or more second users to join the group. In some embodiments, the one or more gaming groups 604 may be automatically suggested by the social-networking system 160 to the first user. The social-networking system 160 may use a machine-learning model to suggest one or more gaming groups 604 to the first user for joining or sharing content from their personal gamefeed space 602. The machine-learning model may take into consideration the first user game history (e.g., which games that the user has played or have been associated with in the past) when suggesting the gaming groups 604.

As discussed earlier, in order to protect user privacy, the social-networking system 160 may, by default, share gaming-moment information including one or more gaming moments on the personal gamefeed space 604 of the user. The user may review the one or more gaming moments in his gamefeed space 604 on the client system 130 and take actions with respect to these gaming moments. For example, the user may add content (e.g., a comment, an instant replay, a photo, a video, etc.) to a gaming moment (as discussed in reference to at least FIGS. 9B and 9C) and choose to share the gaming moment on one or more other social contexts (e.g., one or more gaming groups 602, one or more message threads 606, and/or social media feed 608) within the online social network. In some embodiments, the social-networking system 160 may present a window similar to the sharing window 912 on the client system 130 of the user that the user can use to take actions with respect to the gaming moments in their gamefeed space 604. In particular embodiments, based on the user actions, the social-networking system 160 may update the gaming moments (e.g., by adding comments or attaching media content) and share the updated gaming moments with other users of the online social network, one or more gaming groups 602, in one or more message threads of a messaging application, and/or the social media feed 608.

In particular embodiments, when the social-networking system 160 share gaming-moment information associated with a game on a social context (e.g., the personal gamefeed space 604), the social-networking system 160 may provide a deep link integration between the game hosted on the gaming platform 140 and the online social network of the social-networking system 160. For instance, along with a gaming moment, the social-networking system 160 may provide a deep link element that is selected by the user to go directly into a game context referenced in the gaming moment. As an example, and not by way of limitation, if the gaming moment that is shared on the user's gamefeed space 604 is about the user achieving an all-time high score in the game of “SNAKE”, then the user may click on a deep link element (located somewhere near the gaming moment or in the sharing window 912) to go directly into the context where this indication of gaming moment happened in the gaming platform 140. In this example, if the gaming platform 140 displayed a game leaderboard showing the all-time high score of the user, then upon activating the deep link element, the user may be taken from the online social network to the game leaderboard in the gaming platform 140.

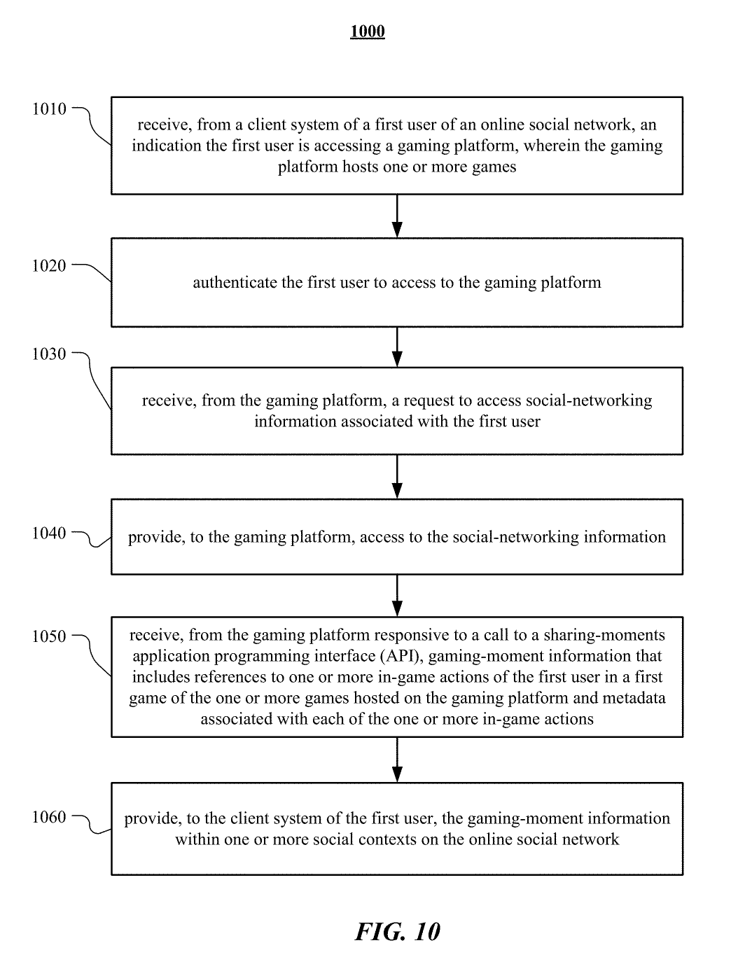

FIG. 10 is a flowchart of an example method 1000 for providing gaming-moment information referencing in-game actions of a user in a game within one or more social contexts on an online social network. The method 1000 may begin at step 1010, where the social-networking system 160 may receive, from a client system 130 of a first user of an online social network, an indication the first user is accessing a gaming platform 140, wherein the gaming platform 140 hosts one or more games. At step 1020, the social-networking system 160 may authenticate the first user to access to the gaming platform 140. At step 1030, the social-networking system 160 may receive, from the gaming platform 140, a request to access social-networking information associated with the first user. At step 1040, the social-networking system 160 may provide, to the gaming platform 140, access to the social-networking information. At step 1050, the social-networking system 160 may receive, from the gaming platform 140, responsive to a call to a sharing-moments API, gaming-moment information that includes references to one or more in-game actions of the first user in a first game of the one or more games hosted on the gaming platform and metadata associated with each of the one or more in-game actions. A step 1060, the social-networking system 160 may provide, to the client system 130 of the first user, the gaming-moment information within one or more contexts on the online social network. Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for providing gaming-moment information referencing in-game actions of a user in a game within one or more social contexts on an online social network including the particular steps of the method of FIG. 10, this disclosure contemplates any suitable method for providing gaming-moment information referencing in-game actions of a user in a game within one or more social contexts on an online social network including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

### Gaming-Context APIs

In particular embodiments, the social-networking system 160 may provide various gaming-context APIs that the gaming platform 140 can use to enhance user gameplay experience when the user is playing one or more games hosted on the gaming platform 140. In particular embodiments, the gaming platform 140 may be a messaging-application-based gaming platform or a mobile platform, which is integrated into a messaging application of the online social network. The messaging-application-based or mobile gaming platform may allow users to access games for playing from within a messaging application using a games tab (as discussed in U.S. patent application Ser. No. 15/783,885, filed 13 Oct. 2017, hereby incorporated by reference), receive game-related messages inside a message thread from a game bot (as discussed in U.S. patent application Ser. No. 15/783,936, filed 13 Oct. 2017, hereby incorporated by reference), and play games with other users from inside message threads (aka gameplay threads) (as discussed in U.S. patent application Ser. No. 15/783,905, filed 13 Oct. 2017, hereby incorporated by reference). Using the gaming-context APIs of the social-networking system 160, the gaming platform 140 may provide rich gameplay features to users of its platform when playing games. These gaming-context APIs may include a switch-context API, a choose-context API, a connected-player API, a sharing-moment API, and a customized-message API. Using the switch-context API, the gaming platform 140 may enable seamless switching between various game contexts so that a user may simultaneously play one or more games with one or more other users. For example, using this API, the gaming platform 140 may enable a first user to switch from a first game context (e.g., a first message thread running a first game between the first user and a second user) to a second game context (e.g., a second message thread running the first game between the first user and a third user). Using the choose-context API, the gaming platform 140 may provide a list of all of a user's connections (e.g., social contacts on the online social network) who have not yet played a game. This API may thus provide a way for the user to invite friends or new people to try out the game. Using the connected-player API, the gaming platform 140 may return a list of player IDs for a game that can be used to compare performance metrics (e.g., score, rank) of a first player with second players in the game. For example, using this API, the gaming platform 140 may generate a game leaderboard showing a user score for a game relative to other users scores when they played the same game before. Using the sharing-moments API, the gaming platform 140 may share gaming-moment information (e.g., in-game highlights, user gameplays, user achievements, etc.) on one or more social contexts (e.g., user personal gamefeed space, message thread(s), social group(s)) within the online social network (as discussed in detail above). Using the custom-message API, the gaming platform 140 may provide customized messages to a user in a message thread (as discussed in U.S. patent application Ser. No. 15/783,936, filed 13 Oct. 2017). A customized message may include, for example, a game screenshot or animated clip (which may show a short preview of a user's gameplay), a user icon showing a picture of the user playing the game, score/rank that the user achieved in the game, a customizable text, and a customizable action button. These gaming-context APIs may be used for different game types or game genres. For example, the API may be used for a solo/single-player game (i.e., where a user is playing a game by himself); a multi-player game (i.e., where two or more users play the game with or against each other); a competitive multi-player game (i.e., where two or more players play the game against each other), a collaborative/cooperative multi-player game (i.e., where two or more player are playing together to finish a game); a turn-based game (i.e., where one or more players take actions in turn); a real-time/live-action game (i.e., where one or more players continuous play over time); or other suitable types of games. Each of the gaming-context APIs is discussed in further detail below.

### Switch-Context API

The switch-context API comprises a set of instructions (defined by the social-networking system 160) that when executed enables the gaming platform 140 to switch game contexts from one game context to another without exiting the game. With this API, the gaming platform 140 may enable a player to switch from playing a game with one friend to another inside the game itself. For example, a player is playing two instances of “Words with Friends” with his two friends, a game with Tom and another game with Harry. When the player has finished playing his turn with Tom, the gaming platform 140 may send a message prompt on the client system 130 of the player asking him if the player now wants to play his turn with Harry. When the player gives the permission, the gaming platform 140 may direct the player to the game with Harry without having him to quit the game with Tom. In particular embodiments, when a player gives permission to the message prompt regarding switching from a first to a second game context, it also gives a permission to a game developer to post/inject content in the second context (e.g., post content in second message thread). In other words, the switch-context API is also a way to ensure that game developers do not inject undesirable content in different threads without user's permission (i.e., until the user has confirmed switching to different message threads). It should be understood that the switching game contexts happen only when different message threads are involved. If multiple players are involved in the same thread (e.g., if you, Tom, and Harry are all playing a single game of “Word with Friends”), then there is no switching of the contexts.

In particular embodiments, the switch-context API enable two different scenarios of switching game contexts. In a first switch game context scenario, the gaming platform 140, via the switch-context API, may enable a first user to switch from a first game context comprising a first game state of a first game between the first user and a second user to a second game context comprising a second game state of the first game between the first user and a third user in a second message thread (as discussed in detail in reference to FIGS. 11A-11C below). In other words, the first game switch scenario enables the first user while he is waiting for the second user to complete a move in a game (e.g., Chess) in a first message thread to switch to a second message thread where the first user is ready to take his move against a third user for the same game. In a second switch game context scenario, the gaming platform 140, via the switch-context API, may enable a first user to switch from a first game context comprising a first game between the first user and a second user to a second game context comprising a second game between the first user and the second user in a second message thread (as discussed in detail in reference to FIGS. 12A-12C below). In other words, the second game switch scenario enables the first user while he is waiting for the second user to complete a move in a first game (e.g., “Chess”) in a first message thread to switch to a second message thread where the first user is ready to take his move against the second user for a second game (e.g., “Words With Friends”).

FIGS. 11A-C illustrate a first example scenario of switching game contexts from a first game context to a second game context via a switch-context API. Generally, these figures show switching from a first game context where a first user “Andrea” has finished playing his turn and waiting for a second user “Alissa” to play her turn for a first game state of a game “Chess” going in between the two users inside a first message thread 1102 (see FIG. 11B) to a second game context having a second game state of the same game “Chess” going in between the first user “Andrea” and a third user “Ben” inside a second message thread 1132 (see FIG. 11C). In particular, FIG. 11A is a user interface 1100 showing the first message thread 1102 containing conversations between the first user “Andrea” and the second user “Alissa” and a game window 1104 showing a first game state of “Chess” that is going between the two users. As depicted, the game window 1104 contains a game title 1106, status indicator 1108 indicating player status (e.g., who started the game, whose turn it is, etc.), the actual game 1110 with live progress updates, player bar 1112 indicating the players involved in the game along with their current status, and an action button 1114 to take an action with respect to the game. The user interface 1100 is presented on a client system 130 of the first user “Andrea” after the second user “Alissa” made a last move. Using the status indicator 1108, the first user “Andrea” may see that “Alissa” made a move and it is his turn now. The first user “Andrea” may then play his turn using the action button 1114. Once “Andrea” plays his turn, a user interface 1120 may be displayed on the first user's screen (FIG. 11B). As depicted, the user interface 1120 of FIG. 11B shows a message prompt 1122 asking the first user “Andrea” if he wants to play with a third user “Ben” while “Andrea” is waiting for the second user “Alissa” to complete her move. Upon receiving an affirmative response from the first user “Andrea” on the message prompt 1122 (as indicated by reference numeral 1124), a user interface 1130 is displayed on the first user's screen, as shown in FIG. 11C. The user interface 1130 of FIG. 11C shows a second message thread 1132 containing conversations between the first user “Andrea” and the third user “Ben” and a game window 1134 showing a second game state of “Chess” that is going between the two users. Similar to the game window 1104, the game window 1134 contains a game title 1136, status indicator 1138 indicating player status, the actual game 1140 with live progress updates, player bar 1142 indicating the players involved in the game along with their current status, and an action button 1144 to take an action with respect to the game. Using the status indicator 1138, the first user “Andrea” may see that Ben made a move and it is Andrea's turn now. The first user “Andrea” may then play his turn using the action button 1144. Once “Andrea” finishes playing his turn, a message prompt (not shown) similar to the message prompt 1122 may be displayed on the first user's screen asking if he now wants to switch back to the first game context to resume playing with the second user “Alissa” in the first message thread 1102. Upon receiving a confirmation, the user interface 1100 will be displayed on the first user's screen where he can now play his turn/move against the second user for the first game state of Chess. In this way, the first user “Andrea” may simultaneously play a game with other users without waiting for another user's turn/move to finish. Even though, the example embodiment depicted in FIGS. 11A-C shows switching game contexts between two message threads, it should be noted that this is not limiting and switching to other message threads is possible and within the scope of the present disclosure. For example, upon finishing the turn in the second message thread 1132, a message prompt may be provided to the first user “Andrea” asking if he wants to switch to a third message thread (not shown) containing a third state of the game “Chess” that is going on between him and a fourth user “Charlie”.

FIGS. 12A-C illustrate a second example scenario of switching game contexts from a first game context to a second game context via the switch-context API. Generally, these figures show switching from a first game context where a first user “Andrea” has finished playing his turn and waiting for a second user “Alissa” to play her turn for a first game “Chess” going in between the two users inside a first message thread 1202 (see FIG. 12B) to a second game context having a second game “Words With Friends” going in between the same two users inside a second message thread 1232 (see FIG. 12C). In particular, FIG. 12A is a user interface 1200 showing the first message thread 1202 containing conversations between the first user “Andrea” and the second user “Alissa” and a game window 1204 showing a game state of “Chess” that is going between the two users. Note that the user interface 1200 is similar to the user interface 1100 in FIG. 11A and therefore, the description will not be repeated here. FIG. 12B is a user interface 1220 that shows on the first user's screen when the first user finishes playing his turn against the second user “Alissa”. As depicted, the user interface 1220 shows a message prompt 1222 asking the first user “Andrea” if he wants to play his turn for a second game “Words With Friends” that is going on between him and the second user in a second message thread 1232. Upon receiving an affirmative response from the first user “Andrea” on the message prompt 1222 (as indicated by reference numeral 1224), a user interface 1232 is displayed on the first user's screen, as shown in FIG. 12C. The user interface 1230 of FIG. 12C shows the second message thread 1232 containing conversations between the first user “Andrea” and the second user “Alissa” and a game window 1234 showing a game state of “Words With Friends” that is going between the two users. Using a status indicator 1236, the first user “Andrea” may see that “Alissa” made the last move and it is his turn now. The first user “Andrea” may then play his turn using the action button 1238. Once “Andrea” finishes playing his turn, a message prompt (not shown) similar to the message prompt 1222 may be displayed on the first user's screen asking if he now wants to switch back to the first game context to resume playing the game “Chess” with the second user “Alissa” in the first message thread 1202. Upon receiving a confirmation, the user interface 1200 will be displayed on the first user's screen where he can now play his turn/move against the second user for the first game.

Choose-Context API

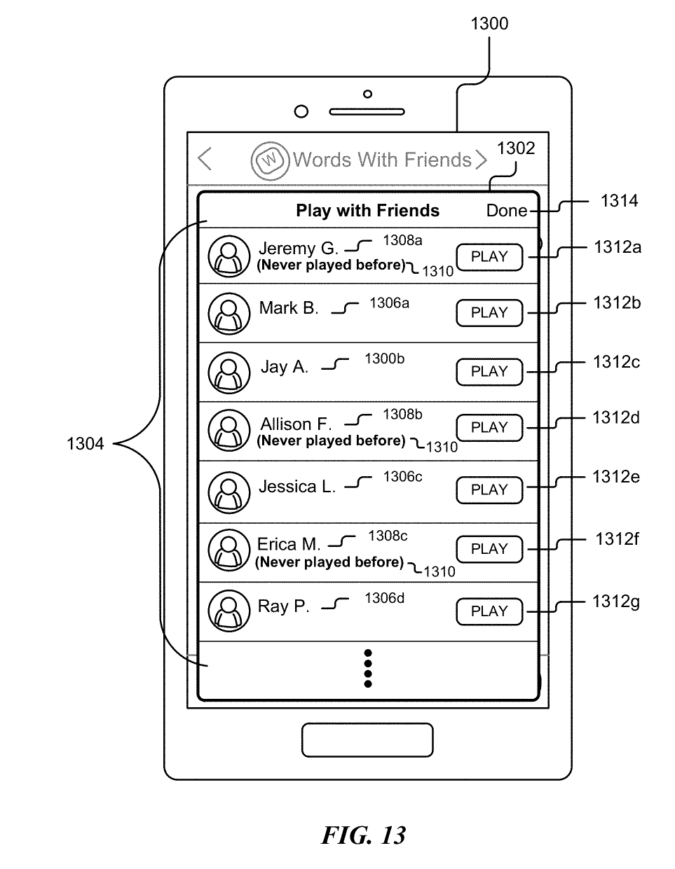

The choose-context API comprises a set of instructions (defined by the social-networking system 160) that when executed enables the gaming platform 140 to provide a list of all of a user's connections (e.g., Facebook friends, messenger contacts, etc.) who have not yet played a game. The choose-context API provides a way for a user to invite friends or new people (who have not yet played) from within the game. By calling this API, the gaming platform 140 provides an interface (e.g., see interface 1300 in FIG. 13) to the user, on the client system 130, with a list of friends who have not yet played the game, from which the user can choose one or more friends to invite to play. The list may be sorted or ranked based on one or more criteria and the list may then be presented in the ranked order. The one or more criteria for ranking may include, as an example and not by way of limitation, a social affinity of the user with respect to each of the friends in the list, a game affinity of the user with respect to each of the friends in the list, a recency of conversation or interaction between the user and a friend, recency of activity between the user and friends on messenger/in games, etc.

FIG. 13 is a user interface 1300 displaying a list of friends for inviting to play a game via a choose-context API. The user interface 1300 may be presented on a client system 130 of a user, such as a mobile device. The user interface 1300 may be generated by a client application running on the client system 130. For example, the client application may be a messaging application within which the user may play one or more games, as discussed elsewhere herein. In particular embodiments, the user interface 1300 may be automatically presented at the start or end of a game. For example, when the user selects to play a certain game, then the user interface 1300 may be presented using which the user can select one or more friends that he wants to play with. In some embodiments, the user interface 1300 may be presented upon user request. For example, the user may select an invite friends tab/element located at some location in the game interface and upon selecting, the user interface 1300 may be presented on the user's client system 130. The user interface 1300 may be presented in response to making a call to the switch-context API discussed herein.

As depicted, the user interface 1300 shows a list of friends for inviting to play the “Words With Friends”. The interface 1300 includes an invite-friends window 1302 containing a list 1304 of friends. The friends may be all the social contacts of a user. For example, the friends may be user's friends on an online social network (e.g., Facebook). The list 1304 comprises a first set of friends who have already played the game before as well as a second set of friends who never played that particular game. For example, as shown in FIG. 13, the list 1304 shows friends 1306a, 1306b, and 1306c who have already played the game before and friends 1308a, 1308b, and 1308c who have not yet played. A status indicator 1310 may be shown for each of the friends 1308a-c (who never played before) to help a user identify these friends in the interface and send invites accordingly. In some embodiments, list of friends may be sorted based on a social or a game affinity associated with each of the friends to the requesting user. The social-networking system 160 or the messaging system 180 may use the social graph 400 or the gamer graph 500 to compute the social or game affinity, respectively, as discussed elsewhere herein. The user may scroll through the list 1304 to view additional friends by performing a swipe-up gesture on the screen of the client system 130. In some embodiments, the user interface 1300 may include a dedicated scroll bar (not shown) that the user can use to scroll up/down through the list 1304 of friends. The user may choose one or more friends by selecting one or more action buttons 1312a . . . 1312g (individually and collectively referred to herein as 1312) corresponding to their names in the list. For example, the user may invite the friend “Jeremy G” by clicking on the “Play” button 1312a. An invite request may then be sent to the chosen friends on their respective client systems 130. Once the user is done choosing the one or more friends, he may click on the “Done” tab 1314 to close the invite window 1302 and return to the game.

Connected-Player API

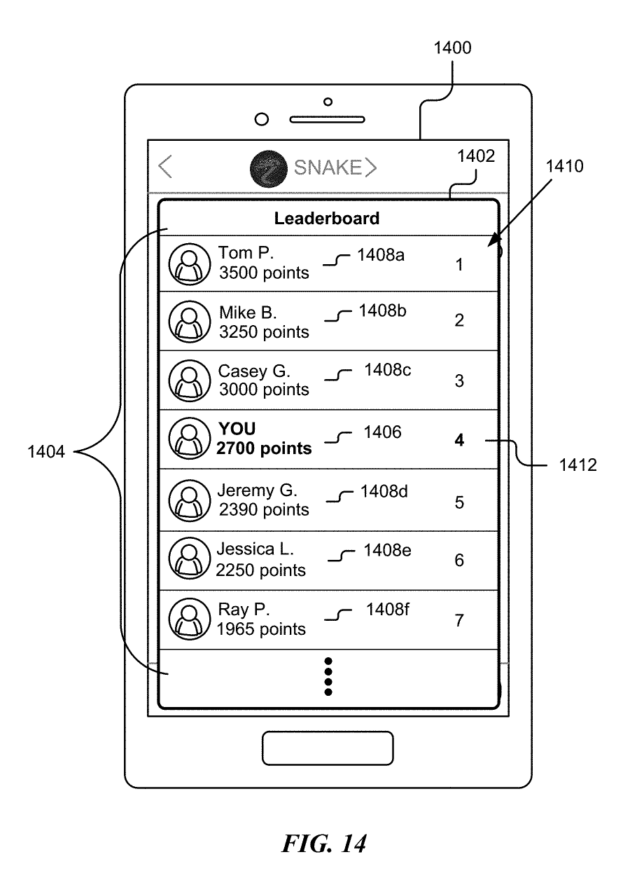

The connected-player API comprises a set of instructions (defined by the social-networking system 160) that when executed enables the gaming platform 140 to return a list of player IDs for a game that can be used to provide in-game features to a user. Player IDs may correspond to users who are connected to the user on an online social network (e.g., Facebook friends or messenger contacts) who have played the same game before. The gaming platform 140 may use the player IDs (returned upon calling the connected-player API) to present useful information to the user at the start, during, or at the end of the game. As an example, and not by way of limitation, once the user has finished playing a game, the gaming platform 140 may call the connected-player API to present a game leaderboard on the client system 130 of the user showing to the user his score/rank compared to his friends who earlier played the game (as shown in FIG. 14).

FIG. 14 is a user interface 1400 displaying a leaderboard 1402 for a game via a connected-player API. The user interface 1400 may be presented on a client system 130 of a user, such as a mobile device. In particular embodiments, the user interface 1400 may be presented at the end of the game. For example, when the user finish playing the game, his performance metrics (e.g., score, rank, etc.) may be shown relative to the performance metrics of other players who are actively involved or have played the same game before. The user interface 1400 may be presented in response to making a call to the connected-player API discussed herein.

As depicted, the user interface 1400 shows the leaderboard 1402 containing a list 1404 of players along with their performance metrics 1410 for the game of “Snake”. The leaderboard 1402 includes the performance metric of the user 1406 who recently played the game as well other players 1408a-1408n who have played the same game before. The other players may be social contacts of the user. For example, the other players may be user's friends on an online social network (e.g., Facebook) who have played the same game at an earlier point in time. In some embodiments, the other players include all the users (whether or not they are connected to the user on the online social network) who have played the same game before. As depicted, the leaderboard 1402 shows the user's ranking in the game compared to other players' rank when they played the same game. For example, the user scored 2700 points and hold a position/rank 4 (as indicated by reference numeral 1412) in the game compared to his friends or other players in the game. The leaderboard 1402 may be sorted for display based on ranking or score. For example, a player with a rank 1 or having the highest score will be shown first, then a player with a rank 2 or second highest score, and so on. The user may scroll through the list 1404 to view additional players and their corresponding performance metrics by performing a swipe-up gesture on the screen of the client system 130. In some embodiments, the user interface 1400 may include a dedicated scroll bar (not shown) that the user can use to scroll up/down through the list 1404.

Sharing-Moments API

The sharing-moments API comprises a set of instructions (defined by the social-networking system 160) that when executed enables the gaming platform 140 to share gaming-moment information (including in-game actions of the user or gaming moments) on one or more social contexts (e.g., newsfeed, message threads, social groups, etc.) within an online social network (discussed in detail above). In particular embodiments, the gaming platform 140 may call this API to send gaming-moment information to the social-networking system 160, which may then share the gaming-moment information on the one or more social contexts 602-608, as discussed elsewhere herein. Currently, sharing options are provided to a user at the end of a game. This API enables the gaming platform 140 to provide sharing of gaming moments at any point. For example, gaming moments, such as game screenshots, achievement data (prizes/awards), user gameplay, game leaderboard, etc., can be shared at the beginning of a game, at the end of the game, or after something interesting happens in the game by calling the sharing-moments API.

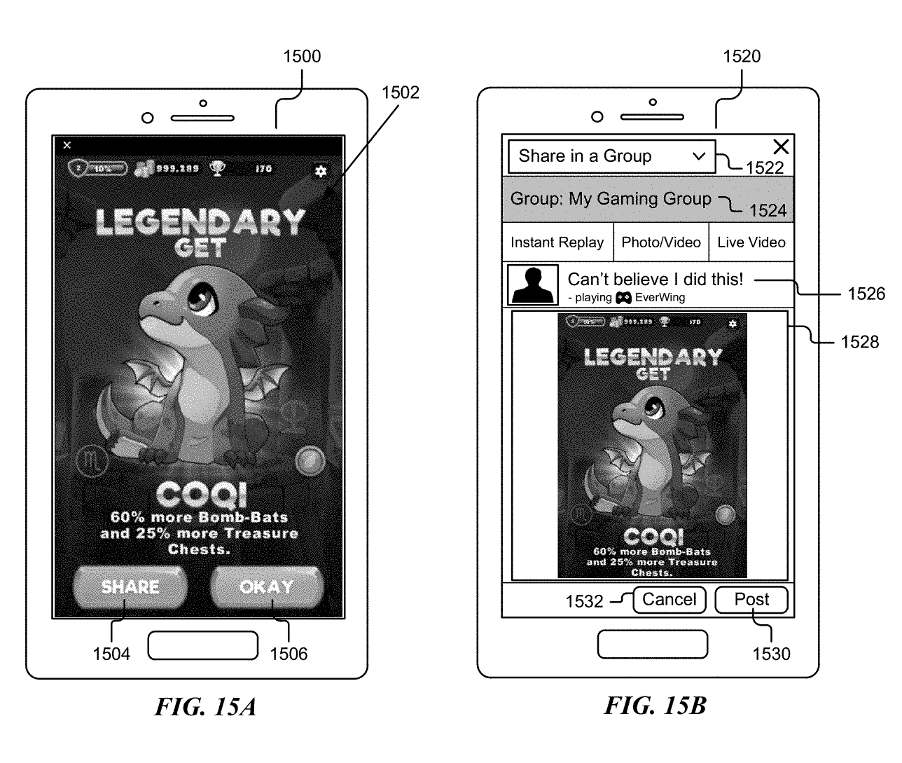

FIGS. 15A and 15B are user interfaces showing an example of sharing a gaming moment on a social context (e.g., a gaming group) within an online social network via a sharing-moments API. In particular, FIG. 15A is a user interface 1500 showing a gaming moment 1502 and actions buttons 1504 and 1506 for taking an action in response to the gaming moment 1502. In particular embodiments, the user interface 1500 may be displayed at the end of the game, whenever the user has achieved some status/award/prize in the game, or when something special happens in the game. As mentioned elsewhere herein, a gaming moment can be a user achievement (e.g., award, prize, unlock, gift, etc.) in a game, in-game highlight (e.g., short video or clip from the user gameplay), a game screenshot, a live game video, etc. As shown in the interface 1500, the gaming moment 1502 shows a dragon and some treasure chests that a user has achieved while playing a game of “EverWing”. The user may take an action with respect to the gaming moment 1502 via the action buttons 1504 and 1506. For example, the user may share the gaming moment 1502, by clicking on the “SHARE” button 1504, on a social context within an online social network, as shown and discussed in reference to FIG. 15B. Otherwise, the user may decide to close the sharing window and return to the game by clicking on the “OKAY” button 1506.

Once the user clicks on the “SHARE” 1504 button, the gaming platform 140 makes a call to the sharing-moments API to present a user interface 1520 (see FIG. 15B). As depicted, the interface 1520 of FIG. 15B includes a social-context selection drop-down menu 1522 for selecting a desired social context on which the user wants to share the gaming moment 1502, a social-context indicator 1524 indicating the chosen social context by the user, a comment section 1526 for inserting a comment on the social context regarding the gaming moment 1502, an in-game moment preview window 1528 showing a preview or screenshot of the gaming moment 1502, a “POST” button 1530 for posting the gaming moment 1502 along with any comments (optional) on the chosen social context, and “CANCEL” 1532 for cancel sharing the gaming moment 1502.

Custom-Message API

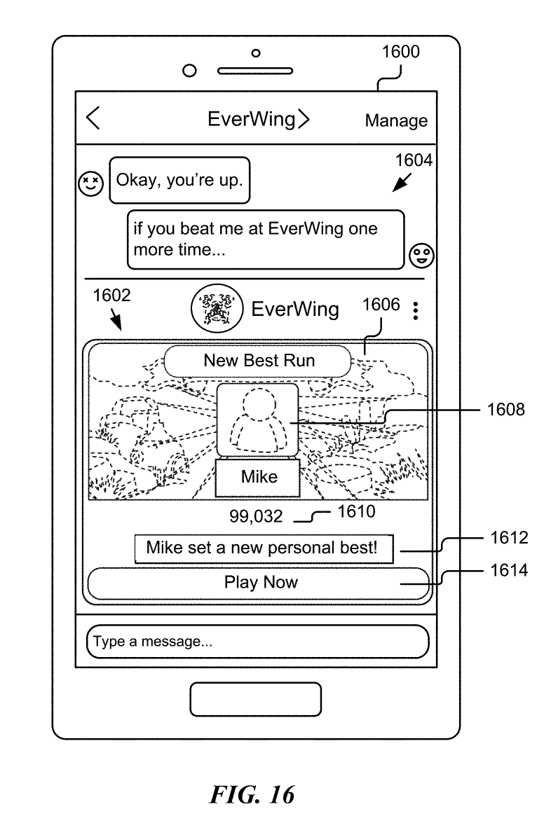

The custom-message API comprises a set of instructions (defined by the social-networking system 160) that when executed enables the gaming platform 140 to provide customized messages to a user in a message thread. A customized message may include, for example, a game screenshot (which upon clicking may show a short preview of a user's gameplay), a user icon showing a picture of the user playing the game, score/rank that the user achieved in the game, a customizable text, and a customizable action button, as shown and discussed in reference to FIG. 16. The text and action buttons may be customizable, such that the text and/or the action buttons could be changed for different instances. For example, in a first instance, the text may be “Mike set a new personal best!” and action button may be “Play Now”. In a second instance, the text and the action button may be customized to say “Mike did a new best run!” and “Join the Game”, respectively. Also, an action button in a customized message may contain a deep link with metadata (e.g., player ID, game status, context data, context key, etc.) so when a user interacts with action button in the customized message, the user may be taken directly to the particular game state from where he left off. In some embodiments, customized messages may be sent by a game bot (discussed in U.S. patent application Ser. No. 15/783,936, filed 13 Oct. 2017, hereby incorporated by reference in its entirety). For instance, the game bot associated with the game may track the game status and/or user performance in the game and send a customized message to a user in a message thread accordingly. In some embodiments, the game bot may use an artificial intelligence technique to generate a customized message.

FIG. 16 is a user interface 1600 showing an example customized message that may be sent in a message thread for a game using a custom-message API. In particular, FIG. 16 is a user interface 1600 showing a customized message 1602 that may be sent by a game bot associated with the “EverWing” game in a message thread 1604. The customized message 1602 may include an interactive screenshot 1606 of the game, a user photo 1608 that may also be customizable, user performance metric 1610 (e.g., score, rank, etc.), a customizable text 1612, and a customizable action button 1614 (e.g., “Play Now”). The screenshot 1606 in the customized message 1602 may be interactive meaning that when a first user interacts with the screenshot, a short video preview of a second user's gameplay could be shown, and then a message allowing a follow-up action could be sent to the first user.

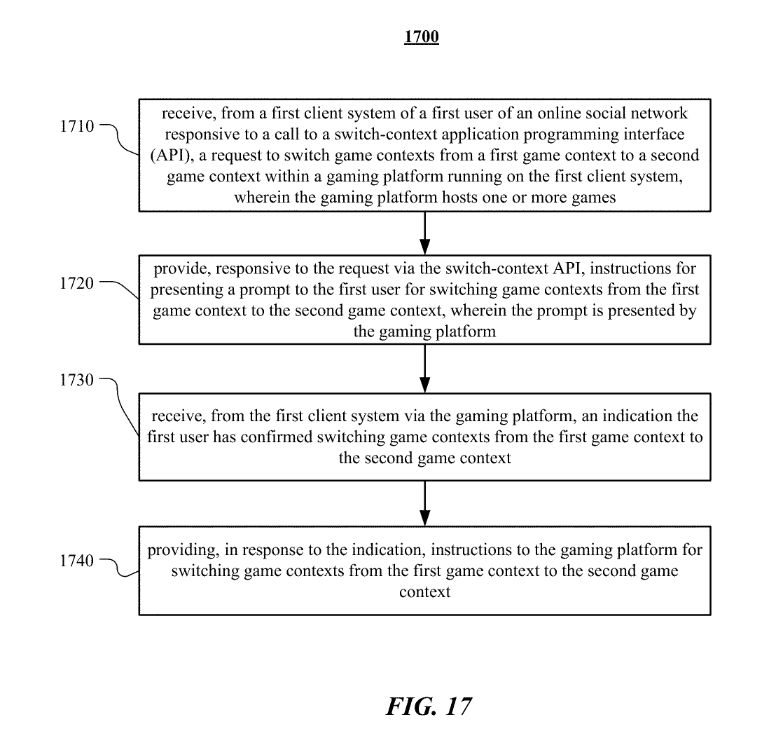

FIG. 17 is a flowchart of an example method 1700 for switching game contexts from a first game context to a second game context. The method 1700 may begin at step 1710, where the social-networking system 160 may receive, from a first client system 130 of a first user of an online social network responsive to a call to a switch-context application programming interface (API), a request to switch game contexts from a first game context to a second game context within a gaming platform 140 running on the first client system 130, wherein the gaming platform 140 hosts one or more games. At step 1720, the social-networking system 160 may provide, responsive to the request via the switch-context API, instructions for presenting a prompt to the first user for switching game contexts from the first game context to the second game context, wherein the prompt is presented by the gaming platform 140. At step 1730, the social-networking system 160 may receive, from the first client system 130 via the gaming platform 140, an indication the first user has confirmed switching game contexts from the first game context to the second game context. At step 1740, the social-networking system 160 may provide, in response to the indication, instructions to the gaming platform 140 for switching game contexts from the first game context to the second game context. Particular embodiments may repeat one or more steps of the method of FIG. 17, where appropriate. Although this disclosure describes and illustrates particular steps of the method of FIG. 17 as occurring in a particular order, this disclosure contemplates any suitable steps of the method of FIG. 17 occurring in any suitable order. Moreover, although this disclosure describes and illustrates an example method for switching game contexts from a first game context to a second game context including the particular steps of the method of FIG. 17, this disclosure contemplates any suitable method for switching game contexts from a first game context to a second game context including any suitable steps, which may include all, some, or none of the steps of the method of FIG. 17, where appropriate. Furthermore, although this disclosure describes and illustrates particular components, devices, or systems carrying out particular steps of the method of FIG. 17, this disclosure contemplates any suitable combination of any suitable components, devices, or systems carrying out any suitable steps of the method of FIG. 17.

### Social Graph Affinity, Game Affinity, and Coefficients

In particular embodiments, the social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems, such as the messaging system 180 or the game managing system 190. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile interfaces, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social-networking system 160 may calculate a coefficient based on a user's actions. The social-networking system 160 may monitor such actions on the online social network, on a third-party system 170, on a messaging system 180, on a game-managing system 190, on other suitable systems, or any combination thereof. Any suitable type of user actions may be tracked or monitored. Typical user actions include viewing profile interfaces, creating or posting content, interacting with content, tagging or being tagged in images, joining groups, listing and confirming attendance at events, checking-in at locations, liking particular interfaces, creating interfaces, and performing other tasks that facilitate social action. In particular embodiments, the social-networking system 160 may calculate a coefficient based on the user's actions with particular types of content. The content may be associated with the online social network, a third-party system 170, an online messaging network associated with a messaging system 180, an online gaming network associated with a game-managing system 190, or another suitable system. The content may include users, profile interfaces, posts, news stories, headlines, instant messages, chat room conversations, emails, advertisements, pictures, video, music, other suitable objects, or any combination thereof. The social-networking system 160 may analyze a user's actions to determine whether one or more of the actions indicate an affinity for subject matter, content, other users, and so forth. As an example and not by way of limitation, if a user frequently posts content related to “coffee” or variants thereof, the social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile interface for the second user.

In particular embodiments, the social-networking system 160 may calculate a coefficient based on the type of relationship between particular objects. Referencing the social graph 166, the social-networking system 160 may analyze the number and/or type of edges 406 connecting particular user nodes 402 and concept nodes 404 when calculating a coefficient. As an example and not by way of limitation, user nodes 402 that are connected by a spouse-type edge (representing that the two users are married) may be assigned a higher coefficient than a user nodes 402 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, the social-networking system 160 may determine that the user has a higher coefficient with respect to the first photo than the second photo because having a tagged-in-type relationship with content may be assigned a higher weight and/or rating than having a like-type relationship with content. In particular embodiments, the social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, the social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 166. As an example and not by way of limitation, social-graph entities that are closer in the social graph 166 (i.e., fewer degrees of separation) may have a higher coefficient than entities that are further apart in the social graph 166.

In particular embodiments, the social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, the social-networking system 160 may determine that the user has a higher coefficient for the airport than the gas station based on the proximity of the airport to the user.

In particular embodiments, the social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social-networking system 160 may provide information that is relevant to user's interests and current circumstances, increasing the likelihood that they will find such information of interest. In particular embodiments, the social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, the social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results interface than results corresponding to objects having lower coefficients.

In particular embodiments, the social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, the social-networking system 160 may calculate the coefficient (or access the coefficient information if it has previously been calculated and stored). In particular embodiments, the social-networking system 160 may measure an affinity with respect to a particular process. Different processes (both internal and external to the online social network) may request a coefficient for a particular object or set of objects. The social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In connection with game affinity and analysis of the gamer graph, described above, particular embodiments may utilize one or more systems, components, elements, functions, methods, operations, or steps described in relation to social-graph affinity and affinity coefficients described above. In particular embodiments, the gaming platform 140 (independently or in cooperation with the social-networking system 160) may determine the game affinity of various game-graph entities for each other. Game affinity may represent the strength of a relationship or level of interest between particular objects associated with the online gaming environment, such as users, games, and other objects associated with the online gaming environment, or any suitable combination thereof. Game affinity may also be determined with respect to objects associated with social-networking systems 160, third-party systems 170, game-managing systems 190, or other suitable systems. An overall game affinity for a game-graph entity for each user, game, or type of object may be established. The overall game affinity may change based on continued monitoring of the actions or relationships associated with the game-graph entity. Although this disclosure describes determining particular game affinities in a particular manner, this disclosure contemplates determining any suitable game affinities in any suitable manner.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile interface that identify a set of users that may access the work experience information on the user-profile interface, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 404 corresponding to a particular photo may have a privacy setting specifying that the photo may only be accessed by users tagged in the photo and their friends. In particular embodiments, privacy settings may allow users to opt in or opt out of having their actions logged by the social-networking system 160, the messaging system 180, or shared with other systems (e.g., a third-party system 170, game-managing system 190, etc.). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, the social-networking system 160 or the messaging system 180 may include authorization/privacy servers for enforcing privacy settings. In response to a request from a user (or other entity) for a particular object stored in a data store 164 or data store 184, the social-networking system 160/the messaging system 180 may send a request to the data store 164/data store 184 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164/data store 184, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

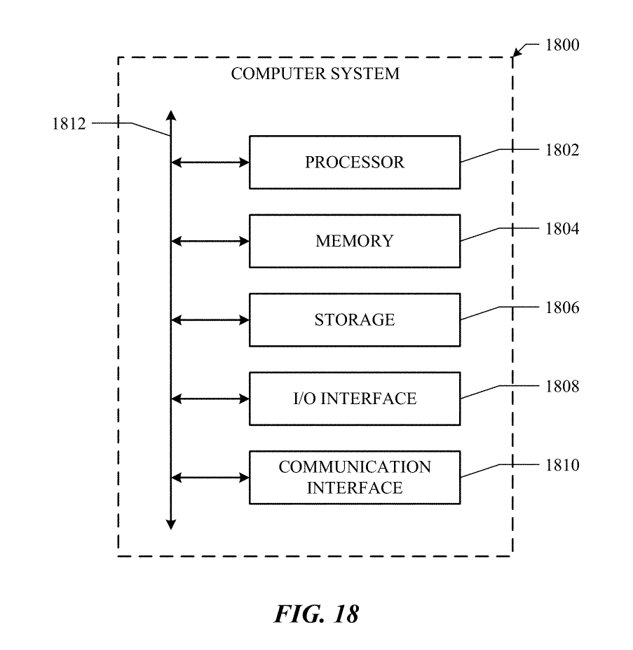

FIG. 18 illustrates an example computer system 1800. In particular embodiments, one or more computer systems 1800 perform one or more steps of one or more methods described or illustrated herein. In particular embodiments, one or more computer systems 1800 provide functionality described or illustrated herein. In particular embodiments, software running on one or more computer systems 1800 performs one or more steps of one or more methods described or illustrated herein or provides functionality described or illustrated herein. Particular embodiments include one or more portions of one or more computer systems 1800. Herein, reference to a computer system may encompass a computing device, and vice versa, where appropriate. Moreover, reference to a computer system may encompass one or more computer systems, where appropriate.

This disclosure contemplates any suitable number of computer systems 1800. This disclosure contemplates computer system 1800 taking any suitable physical form. As example and not by way of limitation, computer system 1800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1800 may include one or more computer systems 1800; be unitary or distributed; span multiple locations; span multiple machines; span multiple data centers; or reside in a cloud, which may include one or more cloud components in one or more networks. Where appropriate, one or more computer systems 1800 may perform without substantial spatial or temporal limitation one or more steps of one or more methods described or illustrated herein. As an example and not by way of limitation, one or more computer systems 1800 may perform in real time or in batch mode one or more steps of one or more methods described or illustrated herein. One or more computer systems 1800 may perform at different times or at different locations one or more steps of one or more methods described or illustrated herein, where appropriate.

In particular embodiments, computer system 1800 includes a processor 1802, memory 1804, storage 1806, an input/output (I/O) interface 1808, a communication interface 1810, and a bus 1812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1802 includes hardware for executing instructions, such as those making up a computer program. As an example and not by way of limitation, to execute instructions, processor 1802 may retrieve (or fetch) the instructions from an internal register, an internal cache, memory 1804, or storage 1806; decode and execute them; and then write one or more results to an internal register, an internal cache, memory 1804, or storage 1806. In particular embodiments, processor 1802 may include one or more internal caches for data, instructions, or addresses. This disclosure contemplates processor 1802 including any suitable number of any suitable internal caches, where appropriate. As an example and not by way of limitation, processor 1802 may include one or more instruction caches, one or more data caches, and one or more translation lookaside buffers (TLBs). Instructions in the instruction caches may be copies of instructions in memory 1804 or storage 1806, and the instruction caches may speed up retrieval of those instructions by processor 1802. Data in the data caches may be copies of data in memory 1804 or storage 1806 for instructions executing at processor 1802 to operate on; the results of previous instructions executed at processor 1802 for access by subsequent instructions executing at processor 1802 or for writing to memory 1804 or storage 1806; or other suitable data. The data caches may speed up read or write operations by processor 1802. The TLBs may speed up virtual-address translation for processor 1802. In particular embodiments, processor 1802 may include one or more internal registers for data, instructions, or addresses. This disclosure contemplates processor 1802 including any suitable number of any suitable internal registers, where appropriate. Where appropriate, processor 1802 may include one or more arithmetic logic units (ALUs); be a multi-core processor; or include one or more processors 1802. Although this disclosure describes and illustrates a particular processor, this disclosure contemplates any suitable processor.

In particular embodiments, memory 1804 includes main memory for storing instructions for processor 1802 to execute or data for processor 1802 to operate on. As an example and not by way of limitation, computer system 1800 may load instructions from storage 1806 or another source (such as, for example, another computer system 1800) to memory 1804. Processor 1802 may then load the instructions from memory 1804 to an internal register or internal cache. To execute the instructions, processor 1802 may retrieve the instructions from the internal register or internal cache and decode them. During or after execution of the instructions, processor 1802 may write one or more results (which may be intermediate or final results) to the internal register or internal cache. Processor 1802 may then write one or more of those results to memory 1804. In particular embodiments, processor 1802 executes only instructions in one or more internal registers or internal caches or in memory 1804 (as opposed to storage 1806 or elsewhere) and operates only on data in one or more internal registers or internal caches or in memory 1804 (as opposed to storage 1806 or elsewhere). One or more memory buses (which may each include an address bus and a data bus) may couple processor 1802 to memory 1804. Bus 1812 may include one or more memory buses, as described below. In particular embodiments, one or more memory management units (MMUs) reside between processor 1802 and memory 1804 and facilitate accesses to memory 1804 requested by processor 1802. In particular embodiments, memory 1804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1804 may include one or more memories 1804, where appropriate. Although this disclosure describes and illustrates particular memory, this disclosure contemplates any suitable memory.

In particular embodiments, storage 1806 includes mass storage for data or instructions. As an example and not by way of limitation, storage 1806 may include a hard disk drive (HDD), a floppy disk drive, flash memory, an optical disc, a magneto-optical disc, magnetic tape, or a Universal Serial Bus (USB) drive or a combination of two or more of these. Storage 1806 may include removable or non-removable (or fixed) media, where appropriate. Storage 1806 may be internal or external to computer system 1800, where appropriate. In particular embodiments, storage 1806 is non-volatile, solid-state memory. In particular embodiments, storage 1806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1806 taking any suitable physical form. Storage 1806 may include one or more storage control units facilitating communication between processor 1802 and storage 1806, where appropriate. Where appropriate, storage 1806 may include one or more storages 1806. Although this disclosure describes and illustrates particular storage, this disclosure contemplates any suitable storage.

In particular embodiments, I/O interface 1808 includes hardware, software, or both, providing one or more interfaces for communication between computer system 1800 and one or more I/O devices. Computer system 1800 may include one or more of these I/O devices, where appropriate. One or more of these I/O devices may enable communication between a person and computer system 1800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1808 for them. Where appropriate, I/O interface 1808 may include one or more device or software drivers enabling processor 1802 to drive one or more of these I/O devices. I/O interface 1808 may include one or more I/O interfaces 1808, where appropriate. Although this disclosure describes and illustrates a particular I/O interface, this disclosure contemplates any suitable I/O interface.

In particular embodiments, communication interface 1810 includes hardware, software, or both providing one or more interfaces for communication (such as, for example, packet-based communication) between computer system 1800 and one or more other computer systems 1800 or one or more networks. As an example and not by way of limitation, communication interface 1810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1810 for it. As an example and not by way of limitation, computer system 1800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1800 may include any suitable communication interface 1810 for any of these networks, where appropriate. Communication interface 1810 may include one or more communication interfaces 1810, where appropriate. Although this disclosure describes and illustrates a particular communication interface, this disclosure contemplates any suitable communication interface.

In particular embodiments, bus 1812 includes hardware, software, or both coupling components of computer system 1800 to each other. As an example and not by way of limitation, bus 1812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1812 may include one or more buses 1812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computer systems:
receiving, from a client system of a first user of an online social network, an indication the first user is accessing a gaming platform, wherein the gaming platform hosts one or more games;
authenticating the first user to access to the gaming platform;
receiving, from the gaming platform, a request to access social-networking information associated with the first user;
providing, to the gaming platform, access to the social-networking information;
receiving, from the gaming platform responsive to a call to a sharing-moments application programming interface (API), gaming-moment information that includes references to one or more in-game actions of the first user in a first game of the one or more games hosted on the gaming platform and metadata associated with each of the one or more in-game actions; and
providing, to the client system of the first user, the gaming-moment information within one or more social contexts on the online social network.

2. The method of claim 1, wherein the gaming-moment information comprise one or more of in-game highlights, game screenshots, live media streams, user achievements, or user gameplays.

3. The method of claim 1, wherein the metadata associated with each of the one or more in-game actions comprise one or more of achievement data, game progression information, user scores, a game leaderboard, or information of the first user and one or more second users connected to the first user within the online social network.

4. The method of claim 1, wherein the one or more social contexts include a personal gamesfeed space of the first user.

5. The method of claim 4, wherein the personal gamesfeed space comprises a game-initiation element that is selectable to execute a deep link to a game context of the first game referenced in the gaming-moment information provided to the personal gamesfeed space, wherein the game context of the game is accessed via the gaming platform.

6. The method of claim 4, further comprising:
receiving, from the client system of the first user, one or more inputs associated with the gaming-moment information in the personal gamesfeed space of the first user;
updating the gaming-moment information based on the one or more inputs;
determining a list of one or more second users with which to share updated gaming-moment information; and
providing, to one or more client systems of the one or more second users, respectively, the updated gaming-moment information within one or more social contexts of the one or more second users in the list.

7. The method of claim 6, wherein the one or more inputs comprise one or more of:
editing the gaming-moment information; or
adding annotations to the gaming-moment information.

8. The method of claim 1, wherein the one or more social contexts include a gaming group comprising the first user and one or more second users of the online social network.

9. The method of claim 8, wherein the gaming group is defined by the first user.

10. The method of claim 8, wherein the gaming group is automatically determined by a machine-learning model.

11. The method of claim 1, wherein the one or more social contexts include a message thread of a messaging application of the online social network.

12. The method of claim 1, wherein the gaming platform is a web-based gaming platform, the web-based gaming platform being located on and part of the online social network.

13. The method of claim 1, wherein the gaming platform is a desktop-based gaming platform, the desktop-based gaming platform integrating features of the online social network into the platform.

14. The method of claim 13, wherein the features of the online social network comprise one or more of a live media feed containing posts relating to the first game or a messaging application for real-time conversation between the first user and one or more second users of the online social network.

15. The method of claim 13, wherein the desktop-based gaming platform is hosted by an external third-party system.

16. The method of claim 1, wherein the gaming platform is a messaging-application-based gaming platform, the messaging-application-based gaming platform being integrated into a messaging application of the online social network.

17. The method of claim 1, wherein the sharing-moments API comprises a set of instructions defined at the online social network, the set of instructions being executable to enable the gaming platform to share the gaming-moment information associated with the first game within the one or more social contexts on the online social network.

18. The method of claim 1, wherein the first user is authenticated via login credentials of the first user on the online social network.

19. One or more computer-readable non-transitory storage media embodying software that is operable when executed to:
receive, from a client system of a first user of an online social network, an indication the first user is accessing a gaming platform, wherein the gaming platform hosts one or more games;
authenticate the first user to access to the gaming platform;
receive, from the gaming platform, a request to access social-networking information associated with the first user;
provide, to the gaming platform, access to the social-networking information;
receive, from the gaming platform responsive to a call to a sharing-moments application programming interface (API), gaming-moment information that includes references to one or more in-game actions of the first user in a first game of the one or more games hosted on the gaming platform and metadata associated with each of the one or more in-game actions; and
provide, to the client system of the first user, the gaming-moment information within one or more social contexts on the online social network.

20. A system comprising: one or more processors; and a non-transitory memory coupled to the processors comprising instructions executable by the processors, the processors operable when executing the instructions to:
receive, from a client system of a first user of an online social network, an indication the first user is accessing a gaming platform, wherein the gaming platform hosts one or more games;
authenticate the first user to access to the gaming platform;
receive, from the gaming platform, a request to access social-networking information associated with the first user;
provide, to the gaming platform, access to the social-networking information;
receive, from the gaming platform responsive to a call to a sharing-moments application programming interface (API), gaming-moment information that includes references to one or more in-game actions of the first user in a first game of the one or more games hosted on the gaming platform and metadata associated with each of the one or more in-game actions; and
provide, to the client system of the first user, the gaming-moment information within one or more social contexts on the online social network.
